(19) United States
(12) Patent Application Publication
(10) Pub. No.: US 2009/0276364 A1
(43) Pub. Date: Nov. 5, 2009

(54) PROCESS CONTROL SYSTEM

(76) Inventors: Vito Iaia, Santa Monica, CA (US); Sean Moriarty, Pasadena, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/435,972

(22) Filed: May 5, 2009

Related U.S. Application Data
(60) Provisional application No. 61/050,543, filed on May 5, 2008.

(51) Int. Cl. G06Q 30/00; G06Q 50/00; G06N 5/02; G06F 17/30

(52) U.S. Cl. 705/80; 705/5; 705/26; 706/47; 707/3; 707/104.1; 707/E17.014; 707/E17.044

(57) ABSTRACT

A computer system configured to provide process control is described herein. The computer system optionally includes a web proxy system, including a load balancer, and a cache cluster. An interface is configured to receive a user search query. A search engine is configured to receive the user query and to identify one or more corresponding events. An interface is configured to display identified events to the user and to receive a user selection of a first event. A data store is configured to store item requests received from a plurality of users for the first event, including corresponding request timing data. An optional servo system is configured to suggest an assignment of items with respect to the first event based at least in part on the number of prior item requests and corresponding request timing data.

### CROSS-REFERENCE TO RELATED APPLICATIONS

This application claims priority to U.S. Provisional Application 61/050,543, filed May 5, 2008, which is incorporated herein by reference in its entirety.

This application is related to U.S. patent application No. [Unknown], filed on the same date as the present application, and entitled “Real Time Data Distribution System”.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

1. Field of the Invention

The present invention is related to process control and in particular, to methods and systems for process control via a networked system using data collected from remote sources.

2. Description of the Related Art

Conventionally, it has proven difficult to predict certain trends regarding a certain types of processes. This is particularly true when there are thousands, tens of thousands or hundreds of thousands of variables.

Further, in certain instances merely monitoring an existing process and using feedback from such monitoring may fail to provide sufficient data so as to adequately enhance or optimize the process.

### SUMMARY OF THE INVENTION

The present invention is related to process control and in particular, to methods and systems for process control via a networked system using data collected from remote sources. Certain embodiments provide enhanced techniques for allocating, routing, and/or distributing resources via a networked computer system.

An example embodiment includes a computer system, comprising: an optional web proxy system, including a load balancer and web proxy processors, wherein the web proxy system is configured to selectively block or route inbound requests from remote terminals to a selected destination; an optional queue configured to receive requests from the web proxy system; an optional transaction system including an optional load balancer and transaction processors configured to generate transactional pages, populate data caches, provide logic and/or rules for the transaction flows, transmit queue related messaging; an optional cache cluster system including a load balancer and cluster system processors, wherein the cache cluster system is configured to cache data and states for access by other computer system components; optionally an interface configured to receive a user search query; an optional search engine configured to receive the user query and to identify one or more events corresponding to the user search query; program code that when executed optionally provides: a user interface configured to present at least a portion of the identified events to the user and to receive a user selection of a first of the identified events; a user interface configured to present fields for requesting a ticket for the first event, wherein a user can specify an acceptable exchange rate regarding the ticket; a data store configured to store ticket requests received from a plurality of users for the first event, including corresponding acceptable exchange rates, and request timing; a servo system configured to suggest allocations of tickets for the first event with respect to at least two different distribution channels based at least in part on the number of ticket requests, exchange rate data, and request timing data; a data store configured to store an indication as to how event tickets are to be allocated to the at least two different distribution channels; and program code that when executed issues at least a portion of tickets acquired via the two different distribution channels electronically.

An example embodiment includes a computer system, comprising: a user interface configured to receive a user search query; a search engine configured to receive the user query and to identify one or more events corresponding to the user search query; program code that when executed provides: a user interface configured to present at least a portion of the identified events to the user and to receive a user selection of a first of the identified events; a user interface configured to present fields for requesting a ticket for the first event, wherein a user can specify an acceptable exchange rate regarding the ticket; a data store configured to store ticket requests received from a plurality of users for the first event, including corresponding acceptable exchange rates, and request timing; a servo system configured to suggest allocations of tickets for the first event with respect to at least two different distribution channels based at least in part on the number of ticket requests, exchange rate data, and request timing data; a data store configured to store an indication as to how event tickets are to be allocated to the at least two different distribution channels; and program code that when executed issues at least a portion of tickets acquired via the two different distribution channels electronically.

An example embodiment includes a computer system including a search engine, comprising: program code stored in computer readable memory, that when executed is configured to provide an interface configured to receive a user search query; a search engine configured to receive the user query and to identify one or more events corresponding to the user search query; program code stored in computer readable memory, that when executed is configured to: provide an interface configured to present at least a portion of the identified events to the user and to receive a user selection of a first of the identified events; provide an interface configured to display fields for requesting a ticket for the first event, wherein a user can specify an acceptable exchange rate regarding the ticket; a data store configured to store ticket requests received via a first distribution channel from a plurality of users for the first event, including corresponding acceptable exchange rates, and request timing; an interface configured to provide information related to the plurality of ticket requests for the first event received via the first distribution channel, including information related to the ticket requests and acceptable exchange rates, wherein the information is configured to be used to determine, at least in part, allocations of tickets for the first event to at least two different distribution channels for the first event associated with different pricing techniques and to determine exchange rates for at least a portion of the allocated tickets; and a data store configured to store an indication as to how event tickets for the first event are to be allocated to the at least two different distribution channels.

An example embodiment provides a method of distributing resources, the method comprising: storing in computer readable memory an allocation indication regarding an allocation of a first subset of resources to a first auction distribution channel using a computer system, wherein resources not included in the first subset of resources are not to be offered to users until offerings via the first auction distribution channel have concluded; causing, at least in part, information regarding the first auction distribution channel to be transmitted over a data network to user terminals; storing information related to how many winning bids were received for resources in the first set of resources in computer readable memory; storing information related to exchange rates associated with the winning bids for resources in the first set of resources in computer readable memory; based at least in part on the winning bid related information, allocating a second subset of resources to a first fixed exchange rate distribution channel; based at least in part on information related to exchange rates associated with the winning bids for resources in the first set of resources, setting and storing in computer readable memory one or more fixed exchange rates to be used in association with the first fixed exchange rate distribution channel; allocating a third subset of resources to a second auction distribution channel; causing, at least in part, information regarding the second auction distribution channel to be transmitted over the data network to user terminals; storing in computer readable memory information related to how many winning bids were received for resources in the third set of resources in computer readable memory; storing in computer information related to exchange rates associated with the winning bids with respect to the third set of resources in computer readable memory; and based at least in part on the winning bid related information for the third set of resources, allocating a fourth subset of resources to at least one distribution channel; based at least in part on information related to exchange rates associated with the winning bids for the third set of resources, setting and storing in computer readable memory one or more fixed exchange rates, to be used in association with at least one fixed exchange rate distribution channel.

An example embodiment provides a method of distributing resources, the method comprising: using a computer system to measure the progression and/or results of a first dynamically-priced ticket sale of a first set of tickets for an event, the first dynamically-priced ticket sale performed at least in part prior to the offer for sale of a second set of tickets via a fixed price sale; based at least in part on information related to the progression and/or results of the first dynamically-priced ticket sale of the first set of tickets: assigning, via the computer system, a number of tickets to be included in the second set of tickets, the second set of tickets including a first subset of tickets at a first fixed ticket price, and a second subset of tickets at a second fixed ticket price; storing in computer readable memory an indication as to which tickets are in the first subset and the corresponding first fixed ticket price; storing in computer readable memory an indication as to which tickets are in the second subset and the corresponding second fixed ticket price; storing in computer readable memory sales information related to the second set of tickets; using the computer system to measure the progression and/or results of a second dynamically-priced ticket sale of a third set of tickets for the event, the second dynamically-priced ticket sale performed at least in part after the offer for sale of the second set of tickets via a fixed price sale; and based at least in part on information related to the progression and/or results of the second dynamically-priced ticket sale of the second set of tickets, assigning a number of tickets for the event to be offered for sale at a third fixed price.

An example embodiment provides a data system for automatically distributing in real time data collected via a plurality of remote terminals, comprising: a web proxy system, including a load balancer and web proxy processors, wherein the web proxy system is configured to selectively block or route inbound requests from remote terminals to a selected destination; a queue configured to receive requests from the web proxy system; a transaction system including a load balancer and transaction processors configured to generate transactional pages, populate data caches, provide logic and/or rules for the transaction flows, transmit queue related messaging; a cache cluster system including a load balancer and cluster system processors, wherein the cache cluster system is configured to cache data and states for access by other computer data system components; a data store configured to store information related to resource requests for dynamically valued resources received from remote terminals, wherein the information includes a resource selection, a resource quantity, and a resource value indication; and program code stored in computer readable memory configured to: automatically transmit to a remote computer system in substantially real a communication that includes information related to: how many resource requests have been received; a resource request rate; which resources have been requested; resource value indications; and after the transmission of the communication, receive and store in computer readable memory an indication as to which distribution channels additional resources are to be allocated.

An example embodiment provides a system for automatically distributing in real time data collected via a plurality of remote terminals, comprising: a data store configured to store information related to resource requests for dynamically valued resources received from remote terminals, wherein the information includes a resource selection, a resource quantity, and a resource value indication; and program code stored in computer readable memory configured to: automatically transmit to a remote computer system in substantially real a communication that includes information related to: how many resource requests have been received; a resource request rate; which resources have been requested; resource value indications; and after the transmission of the communication, receive and store in computer readable memory an indication as to which distribution channels additional resources are to be allocated.

An example embodiment includes a computer system for automatically distributing data collected via a plurality of remote terminals, comprising: a data store configured to store bid information related to auction bids for tickets for an event, wherein the bid information includes an auction identifier, a ticket quantity, and a bid amount; and program code stored in computer readable memory configured to: generate a transmission that includes information related to: how many bids have been received; a bid rate; which types of tickets have been bid for; bid amounts; transmit the transmission to a first designated recipient; receive an indication as to which distribution channels additional tickets are to be allocated; and store the indication in the data store.

An example embodiment provides a method of collecting and distributing data, comprising: receiving over a network at a data collection computer system bid information related to auction bids for tickets for a first event, wherein the bid information includes an auction identifier, a ticket quantity, and a bid amount; generating a transmission that includes information related to: how many bids have been received; a bid rate; which types of tickets have been bid for; bid amounts; transmitting the transmission to a designated recipient; receiving an indication from the designated recipient instructions for tickets to a second event; enabling sales for tickets for the second event to be conducted in accordance with the instructions.

Other embodiments can include combinations of various features described above or elsewhere herein.

### BRIEF DESCRIPTION OF THE DRAWINGS

Embodiments of the present invention will now be described with reference to the drawings summarized below. These drawings and the associated description are provided to illustrate example embodiments of the invention, and not to limit the scope of the invention.

FIG. 1-FIGS. 1A-B illustrate an example system embodiment that can be used in conjunction with processes described herein.

FIGS. 2A-B illustrate a first example process.

FIGS. 3A-4B illustrate example interfaces.

### DETAILED DESCRIPTION OF PREFERRED EMBODIMENTS

The processes and systems described herein enhanced techniques for allocating, routing, and/or distributing resources via a networked computer system. For example, certain embodiments more efficiently allocate resources in accordance with resource requests. In certain example embodiments, feedback is used in the form of a servo loop to provide control of resource valuations. This serves to overcome the technical challenge posed with respect to electronically determining resource allocations, routings, and/or distributions. Certain optional techniques described herein, including the use of the servo loop, reduce or eliminate the need for human intervention in performing resource allocation, hence enabling a computer system to process resource allocations more quickly and efficiently, and with finer control. Certain embodiments enable a resource requester to reallocate/route resources so that the resources are allocated to a relatively higher value use.

Unless otherwise indicated, the functions described herein may be performed by software modules including executable code and instructions running on one or more general-purpose computers. The computers can include one or more central processing units (CPUS) that execute program code and process data, memory, including one or more of volatile memory, such as random access memory (RAM) for temporarily storing data and data structures during program execution, non-volatile memory, such as a hard disc drive, optical drive, or FLASH drive, for storing programs and data, including databases, which may be referred to as a “system database,” and a wired and/or wireless network interface for accessing an intranet and/or Internet.

In addition, the computers can include a display for displaying user interfaces, data, and the like, and one or more user input devices, such as a keyboard, mouse, pointing device, microphone and/or the like, used to navigate, provide commands, enter information, provide search queries, and/or the like. However, the systems described herein can also be implemented using special purpose computers, terminals, state machines, and/or hardwired electronic circuits.

Further, the example processes described herein do not necessarily have to be performed in the described sequence, and not all states have to be reached or performed. In addition, certain process states that are illustrated or described as being serially performed herein, can be performed in parallel.

Throughout the following description, the term “Web site” is used to refer to a user-accessible server site that implements basic and/or other World Wide Web standards for the coding and transmission of documents, such as hypertextual documents. These standards currently include HTML (the Hypertext Markup Language), which can be used to generate Web pages, and HTTP (the Hypertext Transfer Protocol). It should be understood that the term “site” or “computer system” are not intended to imply a single geographic location, as a Web or other network site can, for example, include multiple geographically-distributed computer systems that are appropriately linked together. Furthermore, while the following description relates to an embodiment utilizing the Internet and related protocols, other networks, such as a network of interactive televisions, wireless phones, and other protocols, may be used as well.

While the following discussion may often relate to computer resources (e.g., processor time, network bandwidth, database access) in order to illustrate the use and application of the disclosed systems and methods, the disclosed systems and methods can be applied to other types of units, inventory, or finite resources, such as tickets (e.g., a voucher to indicate that one has paid for or is entitled to admission to a theatre, sporting event, concert, lecture, amusement park, zoo, aquarium, museum, or other attraction, or entitled to travel on an airplane, public transit, train, or other mode of transportation, and may indicate that the holder is entitled to use a specific seat), other priority rights, products, etc. The term “seller” as used herein may be used to refer to artists, promoters, venue operators, resellers, etc.

While certain processes for setting prices, minimum bids, and auction reserve prices are described herein, other process can be used as well, such as those described in co-pending U.S. patent application Ser. No. 11/386,459, incorporated herein by reference in its entirety.

As described herein, certain example embodiments optionally use dynamic pricing data, such as auction data, to determine the manner, timing, rate, and/or pace of ticket distribution and pricing for an event promoter's (or other entity) initial sale of a ticket (e.g., in an “initial sale” offering), thereby helping the entity (or entities) manage the sale of tickets (for example, to reduce inventory risks and increase revenue) in the initial sale offering or otherwise. The data can be obtained via a presale auction and/or continuous smaller auctions that occur simultaneously with the sales cycle in the initial sale of tickets to the event. The market data can also be obtained, in addition or instead, via information obtained from ticket resells (e.g., where a ticket buyer resells a ticket to another ticket buyer). Further, the use of a presale can reduce the demands placed by users upon servers that will be handling the main distribution channel at a later time as a certain portion of purchasers will have already purchased tickets in the presale. Still further, the use of various distribution channels can enable the printing of physical tickets by the system over a larger time frame, thereby reducing the load on the ticket printers.

Certain example embodiments execute one or more alternate processes in conjunction with a first process (which may optionally be a main distribution channel via which the majority of resources, such as tickets, are distributed) so as to gather information from a plurality of sources as feedback. The feedback is then optionally used by a software servo mechanism or otherwise to enhance or modify certain characteristics related to the first process. Optionally, multiple modified processes are run in parallel with the first process. Optionally, certain alternate processes are run prior to running the first process, and certain of the alternate processes are run while the first process is running.

The first process and/or the alternate processes, by way of example, can be used respect to resource allocation/routing and/or establishing resource values.

For example, a first process (executed at least in part by an allocation system) can be used to allocate a first type of resource (e.g., which may have an associated expiration date or time at which point the resources cannot be used for their intended purpose, or which instead is not perishable) in exchange for second type of resource. A fixed resource exchange ratio may be established.

For example, the first process can post a first fixed exchange ratio for resources on a website to requesters (which include potential requesters) that specifies the amount of the second type of resource that needs to be provided to a holder of the first resource in order to be allocated a specified amount of the first type of resource. Optionally, a limitation may be placed on the amount of the first type of resource that is to be allocated to a given requester.

In order to determine an appropriate fixed exchange ratio (e.g., to enhance or maximize the total resources received in exchange and/or to reduce the amount of unallocated resources), in an example embodiment, a second type of process may be run. Rather than simply using a fixed exchange ratio, the second type of process (also referred to herein as an information gathering process, although optionally information can also be gathered via the fixed exchange rate process) obtains substantially real-time valuation information from requesters.

For example, if there is a fixed or substantially fixed amount of a first type of resource, one or more selected groups or subsets of the first type of resource can be auctioned off to requesters or to a subset of requesters. In such an auction, for example, winning bidders in a resource auction can be determined based on the bid amounts, the timing of the bids, the number of resource bids, and the amount of resources being auctioned. Auctioned resources can then be allocated to the winning bidders.

If the subset of resources includes resources of different subtypes (e.g., of different quality), the resources in the subset of resources can be ranked (e.g., the highest quality resources having a corresponding highest/first ranking, the second quality resources having a corresponding second highest ranking, and so on). If the items are of different subtypes, then the highest ranked bidder is optionally allocated the highest ranked resource, the second highest ranked bidder is allocated the second highest ranked resource and so on. The bidder ranking may be based on the bid amount, the number of resources being bid for, the timing of the bid, membership in an organization, maximization of resource sales, and/or other factors.

The timing of the information gathering processes, the number of information gathering processes, and the amount and/or quality (or identity) of resources to be allocated by a given information gathering process can be selected (e.g., manually, automatically, or partially automatically and partially manually) using a selection process based on one or more of the following criteria and/or other criteria (which may be stored and accessed from computer readable memory:

the total amount of resources available for allocation before allocation processes are executed;

the amount of remaining resources available for allocation at certain times after at least one resource has been allocated;

the period specified in which both the fixed exchange rate process(es) are to be run (e.g., specified via a beginning and end dates/times);

a pre-specified period in which the first of the information gathering processes can begin and/or when the last information gathering process is to end;

maximum specified interval between information exchange processes;

a specified maximum number of information process runs that are to be conducted;

specified maximum exchange rates;

specified minimum exchange rates;

specified maximum permissible exchange rate adjustment increment;

specified minimum permissible exchange rate adjustment increment;

specified maximum permissible resources that are to be allocated using information gather process (e.g., via auctions);

specified minimum permissible resources that are to be allocated using information gather process (e.g., via auctions);

the type of resource being allocated;

rankings associated with resources;

the predicted demand for the resources;

the actual demand for resources at one or more periods of demand (as measured by the fixed exchange rate process(es) and/or the information gathering process(es));

the actual rate of increase or decrease demand for resources at one or more periods of demand (as measured by the fixed exchange rate process(es) and/or the information gathering process(es)); and/or

other criteria discussed herein.

Thus, for example, if the demand rate and the acceleration of the demand rate indicate that the amount of remaining resources available for allocation will be or are likely to be allocated within a predetermined period, then an auction may be automatically or manually initiated to determine if the exchange rate should be increased for future allocations.

By way of illustration, if the resources are event tickets, and if the demand rate and the acceleration of the demand rate indicate that the amount of remaining tickets will be allocated within 1 week of being offered for sale or more than 4 weeks prior to the event (indicating that the current ticket price is too low), then an auction can be initiated in accordance with corresponding auction initiation instructions. The minimum bid/reserve price can optionally be set at the current face value of tickets for comparable seats being sold at the fixed exchange rate, or at a certain amount or percentage above the current fixed exchange rate (e.g., $10 more or 15% more).

If a minimum specified interval between auctions has been set (e.g., to avoid confusion and/or overexposure of auctions, to enhance the impression of a time limited opportunity, etc.), or the current day or time is in a pre-specified “no auction” period, the next auction may be delayed until that time or period has passed. If there the current day/time falls after a pre-specified auction cutoff date/time (in which no further auctions are to be conducted), then the auction is not initiated.

The auction can be conducted, and based on the number of tickets sold, the rate of sale, and the number of bids (e.g., winning and/or losing bids), the bid amounts (e.g., the maximum winning bid, the lowest winning bids, and/or the bid distribution in between), a new fixed price exchange rate can be set for a set of tickets. Optionally, the new fixed exchange rate can be set so as not to exceed a specified maximum permissible exchange rate adjustment increment. Optionally, the new fixed exchange rate can be set so that it includes at least a pre-specified minimum permissible exchange rate adjustment increment.

Optionally, in addition or instead of gathering resource valuation information as described above, resource allocations being performed by one or more another entities (e.g., for substantially similar resources, such as similar quality seat tickets for an event) and the associated specified exchange rates are monitored. The resources being allocated by the other entities (e.g., in the case of tickets, a ticket agency or scalper) may have first been first obtained by the other entities (or by a third party that provided to the other entity or entities) via one or more of the processes described above and which they are now reallocating.

The resource valuation information can be automatically obtained via a computer-based monitoring system. For example, the system can monitor one or more Websites or other data stores using an XML publication of such information by the Websites, and/or the system can employ a crawler/spider to crawl the Websites, parse/identify data therein (e.g., item name, description, sale price, etc.), and store such data in a data repository, such as an SQL server or otherwise, for later retrieval and processing. This enables the system to more quickly and accurately acquire and process valuation information, and reduce the work load of the system that would be associated with a user manually accessing the system, viewing third party Websites, entering the information, and correcting the information. Further, because the system will gather data that is specifically useful for determining resource allocation for a given event, unnecessary data is optionally not collected or stored, reducing system memory requirements. Still further, because the information is optionally gathered in substantially real-time, the information can optionally be used by the servo system to adjust allocations to various distribution channels in substantially real-time. In addition or instead, the data can be manually collected by a human data collector viewing the third party websites, by calling such third parties, from information mailed in, or otherwise, to obtain some or all of the following information:

stated resource exchange rates (e.g., for substantially similar resources, such as tickets to a given concert and/or similar concerts, of a similar quality, such as a similar seating row and/or section);

the amount of resources available from the third parties (e.g., for substantially similar resources);

the quality of resources available from the third parties (e.g., for seat tickets, the seating section, row, and/or seat);

the length of time that elapsed until the resources become unavailable (e.g., because they have allocated);

the number of other entities allocating resources;

the location of other entities allocating resources.

The collected data can be stored in computer readable memory for later access and used to determine at least in part resource exchange rate information.

Optionally, rather than using an auction, certain resources can be distributed at an exchange rate that will not change. For example, if the resources are event tickets, a first subset can be designated to be sold at a fixed price, wherein once the price is posted, it will not change (or at least not increase), regardless of feedback received from a concurrent auction or information obtained from other resale markets (e.g., resale markets). However, historical ticket sales information (e.g., rate of ticket sales per price band/seating area for one or more historical events, total ticket sales per price band/seating area for one or more historical events, ancillary revenues for one or more historical events, ratio of ancillary revenues to tickets sold for one or more historical events, what ticket brokers have sold tickets for similar events) from events may be used to set the price initially. Other data that may be utilized in setting ticket prices (as well as minimum bids/ticket reserves in the auction channel) can include some or all of the following types of data:

Venue capacity (e.g., total seating capacity for event for which tickets are being priced);

Venue seat configuration (e.g., the number and types of seating areas, the capacity of different seating areas, seat rankings, seating area rankings, etc.);

Cost data (e.g., related to hosting and running event);

Price constraints (e.g., maximum ticket price for each seating area and/or the venue as a whole, minimum ticket price for each seating area and/or the venue as a whole);

Ticket discounts being offered to certain groups or types of potential purchasers;

Discounts being offered to certain groups or types of potential purchasers for ancillary items (concessions, merchandise, parking);

Limits on the minimum number of tickets a user can purchase;

Limits on the multiple of tickets a user can purchase (e.g., multiples of two);

applicable specified convenience charges (e.g., where different convenience fees may be charged for different purchasing channels (e.g., phone, Internet, ticket outlet, venue box office, etc.);

Characteristics of potential ticket purchaser population (e.g., population size of relevant ticket buying population, motivation for attending event, income, predicted or estimated patience, the ticket price that would cause an estimated percentage of the relevant population not to buy a ticket, and the ticket price that would cause an estimated percentage of the relevant population to buy a ticket).

In addition to utilizing some or all of the foregoing types of information in setting or adjusting prices in the unbounded channel, some or all of the following types of data may also be utilized in setting or adjusting prices:

Limits on price adjustment frequency (e.g., once every 24 hours, twice every seven days, three times a month, etc.);

Limits on the total number of price adjustments per event (e.g., three times, four times, etc.);

Limits on the price decrease per price adjustment (e.g., $5, $7, or a percentage of the initial ticket price);

Limits on the total price decrease (e.g., $15, $21, or a percentage of the initial ticket price);

Limits on the price increase per price adjustment (e.g., $4, $6, or a percentage of the initial ticket price);

Limits on the total price increase (e.g., $12, $18, or a percentage of the initial ticket price) specified by an authorized entity (e.g., the performer, promoter, venue operator, governmental entity, etc.);

Limits on the maximum number of tickets a user can purchase per event or for multiple related events specified by an authorized entity.

Thus, resources, such as event tickets, can be distributed using several different processes including some or all of the following:
via an auction in an initial sale offering/market (the offering/market in which the first sale of a given ticket occurs) and/or other offering/market (e.g., a redistribution/resale offering/market);
via a fixed exchange rate process in the initial sale market and/or resale market, wherein the tickets are offered for sale at a set price determined prior to the offer for sale and not dynamically adjusted once posted;
via a process that periodically releases tickets in the initial sale offering/market and/or resale offering/market for an event, wherein the ticket price for a first ticket may be adjusted after the beginning of the sale of other tickets for the event, but prior to release of the first ticket, wherein once offered for sale, the first ticket price remains fixed;
via a process that periodically releases tickets for an event, wherein the ticket price for a first ticket is specified, and a user may elect to purchase the ticket at the ticket price, but prior to a user offering the pay the ticket price (e.g., prior to the user adding the ticket to the user's electronic shopping and/or completing a payment process), the price may be adjusted.

The sales via one channel may be used in a feedback manner to set the exchange rate (e.g., ticket price) for other tickets in the distribution channels.

When there are resources of the same type but of different quality being allocated, an information gathering process can offer resources of each quality group or a subset thereof in order to determine the value and exchange rates of each quality group using one or more of the distribution processes described herein. For example, if seat tickets are being allocated, and an auction (occurring before the more general sale of tickets using a fixed exchange) is used to gather information to set ticket prices for the general sale, then, for example, one or more seats (or at least a pair of seats) in each row (or in a group of rows) and in each seating section (e.g., floor, box, orchestra, mezzanine, balcony, center, side, etc.), or a subset thereof, may be auctioned. The distribution may be automatically or manually specified based on venue seating data, and the distribution specification is stored in memory.

If a range of sale prices was achieved for seats within a group during an auction (e.g., with a distribution of sale prices between a low winning bid and a high winning bid), the price for the fixed exchange rate sale is optionally calculated using some or all of the winning bids and/or other bids (e.g., losing bids) for seat tickets auctioned from within the section area, optionally based at least in part on a central tendency, such as the:

average;

median;

mode (the most frequent bid amount in the set of winning bids);

geometric mean (the nth root of the product of n data values);

harmonic mean (the reciprocal of the arithmetic mean of the reciprocals of the data values);

quadratic mean or root mean square (RMS) (the square root of the arithmetic mean of the squares of the data values);

generalized mean (the nth root of the arithmetic mean of the nth powers of the bid amounts);

weighted mean (an arithmetic mean that incorporates weighting to certain data elements);

truncated mean (the arithmetic mean of data values after a selected number or proportion of the highest and lowest bid amount data values have been discarded);

midrange (the arithmetic mean of the highest and lowest values of the bid amounts or distribution);

Winsorized mean (the arithmetic mean of bid amount values after a selected number or proportion of the highest and lowest bid amount data values have been set equal to the largest and smallest bid amount values that remain);

exponential mean;

trimean (calculated by adding twice the sum of the mean to the sum of the 25th percentile and 75th percentile and then divide the sum by four);

trimedian (calculated by adding twice the sum of the median to the sum of the 25th percentile and 75th percentile and then divide the sum by four); or normalized mean;

of some or all of the winning bids (and/or losing bids). Optionally, a discount factor (e.g., 5%, 10%, 15%, 20%, 25%, 30%, 40% or other percentage) can be applied to a mean or average (calculated as discussed above) and used with respect to a fixed exchange rate if it is determined that those participating in an auction tend to be more motivated to purchase the resource/ticket (e.g., because they tend to more dedicated fans) relative to those who obtain the resources at a fixed exchange rate, and tend to be willing to pay a higher price for those resources than those purchasing resources at a fixed exchange rate.

The discount or multiplier factors may be determined by setting an exchange rate for a small set of tickets at a first price based on the auction results (e.g., at the average or media winning bid price), conducting a sell of the set of tickets at the first price, and if they fail to adequately sell (e.g., less than all or less than a certain percentage sell), or the sell rate is less then expected or desired, the first price can be reduced and used with respect to additional ticket offers. If the tickets in the relatively small set sellout or above a certain percentage sell, or if the sell rate is higher then expected, the first price can be increased and used with respect to additional ticket offers (e.g., via an auction or fixed exchange rate sale). The foregoing process is optionally repeated until a desirable fixed exchange rate is found (e.g., a fixed exchange rate that will maximize or enhance the total revenue received from tickets sales (e.g., the number of tickets sold*ticket price), or that will enhance or maximize revenues from tickets sales and concessions/ancillaries).

Certain illustrative examples of the processes discussed above will now be provided. In a first example, an information gathering auction may indicate (by the number of bids and the bid amounts) that ticket purchasers are willing to pay about $400-$500 for tickets in the first row, center section, and are willing to pay $200-$300 for seats in the second through tenth row, and so on. In this example, the foregoing prices for the front row that potential ticket purchasers are willing to pay are inferred from the lowest winning bid ($400), the highest winning bid ($500), the median winning bid (e.g., $420) and the fact that all seats offered in the first row, center section were sold. Then, during a fixed exchange sale (or sale where a set price is specified, but the price can be adjusted prior to it being accepted by user), tickets in the first row can be priced at $420 (equal to the median winning bid), and tickets in the second through tenth row can be priced at $210, etc.

As similarly discussed above, in addition to the bid amounts, the rate and time distribution of the bids can be used to set the exchange rates. For example, if a high rate of bids are received over the entire course of the auction, this indicates a generally high degree of interest from users, and the fixed exchange rate may be set relatively higher (e.g., at or above the average or median winning bid). By way of illustration, in such a scenario, the first row, center section seats discussed above may be priced at $450. If a low rate of bids are received over the entire course of the auction and a significant percentage of the tickets were not sold (e.g., less than 70%, 60%, 50%, or other threshold), this indicates a generally low degree of interest from users, and the fixed exchange rate may be set relatively lower (e.g., lower than the average or median winning bid, such as at the lowest winning bid).

By way of further example, if a high rate and/or number of bids are received initially (e.g., the first 2 days or week), but the rate and/over number of bids over the remainder of the auction is at a low level, this may indicate that there is a high degree of interest from very dedicated fans, but not from the more typical target ticket purchaser. In such a scenario, the exchange rate may be fixed at or lower than the lowest winning bid, although optionally the exchange rate can be set higher than the lowest winning bid.

The auction information may also be used to determine how to group resources for pricing purposes (and, in the case of a future auction, with respect to reserve prices or minimum bids). For example, two more auctions may be used to determine how sensitive consumers are to prices for certain groups/types of seats. By way of illustration, an auction may be conducted for seats within the 25^{th} to the 50^{th} rows, and another auction may be conducted for seats within the 50^{th} to the 75^{th} rows. The bids in the auctions may reveal that people are willing to pay approximately the same for seats in the 50^{th} to the 75^{th} row as the 25^{th} to the 50^{th} row (e.g., where the bid amounts are similar). By way of further illustration, an auction may be conducted for seats within the 2^{nd} to the 5^{th} row, and another auction may be conducted for seats within the 6^{th} to the 24^{th} rows. The bids in the auctions may reveal that people are willing to pay significantly more for seats in the 2^{nd} to the 5^{th} row than the 6^{th} to the 24^{th} rows (e.g., where the bid amounts tend to be significantly higher for the 2^{nd} to the 5^{th} rows than the 6^{th} to the 24^{th} rows). Thus, the allocation system may define the remaining seats in the 25^{th} to 75^{th} as being in a first price group (having the same ticket prices) in the fixed exchange sale, the remaining seats in 2^{nd} to the 5^{th} rows as a second price group (with a higher ticket price than those in the first group), and the remaining seats in the 6^{th} to the 24^{th} rows as a third price group (with a higher ticket price than those in the first group and with a lower ticket price than those in the third group).

In addition, some or all of the distribution processes described above can be utilized (e.g., by an event promoter, venue, or performer) to determine which resource (e.g., tickets) should be held in reserve. For example, the tickets held in reserve may be tickets that are not offered for sale during an initial sale, but that are held in reserve for later for later distribution to the public, to the performer (who can distribute them to others), to high value customers, to the press, to radio/television stations or Internet sites for promotional purposes, etc. The reserved tickets can be used to determine pricing in the initial sale market, and can be used to help a promoter manage the sales of tickets, including those offered during the first sale of a given set of tickets to the public (for example, to reduce inventory risks and increase revenue).

In an example embodiment, the allocation of resources to different distribution channels can be dynamically adjusted using substantially real-time or recent information regarding the effectiveness of the available distribution channels for a particular event. For example, tickets or other resources can be offered via: an auction distribution channel; a fixed exchange rate sale channel, wherein once an event ticket is offered for sale, the price of that ticket will not change; a continuous fixed exchange rate channel, wherein once an exchange rate is sets for seat tickets for a given class of event seats, the exchange rate will not change for that class of event seats; a unbounded fixed exchange rate channel, wherein seat tickets comparable to those in a class in the continuous fixed exchange rate can be different in price; and/or a dynamically adjustable set exchange rate sale channel (e.g., wherein the seller can change the specified price of a ticket after the ticket is posted but before it has been purchased).

Initially, one or more channels may be associated with a certain amount of tickets (e.g., event seat tickets, which may be concentrated in one or more seating areas, or which may be distributed over a variety of seating areas/rows in order to gather demand information across the event seats). Optionally, each distribution channel is associated with a corresponding different user interface (e.g., web page), via which users can view pricing information, make offers and/or purchase tickets.

Example user interfaces will now be discussed. Optionally, a search field or fields may be provided via a Web page or otherwise that enables a user to locate available tickets for a given event (e.g., wherein the user can search by keywords, event category (concert, sporting event, family entertainment, etc.), and/or location (e.g., by venue, zip code, city, etc.)). The search criteria are provided to a search engine, which generates a listing of events meeting the search criteria, and the list is displayed to the user. Optionally, a list entry includes some or all of the following information or a link to some or all of the foregoing information:

Event name;

Performer(s) name(s)

Event date;

Event day (e.g., Monday, Tuesday, etc.);

Event time;

Event location;

Venue name;

Ticket distribution channels for the Event (e.g., fixed price sale, resale market sale, auction, etc.).

Optionally, links to the various distribution channel web pages are provided, wherein if the user selects such a link, the corresponding user interface is presented to the user.

If a user visits an example ticket auction web page for an event, the user will optionally be provided with a description of the auction process, the steps that need to be taken in order to participate in the auction and auction rules. The rules may include eligibility rules and authorization rules, non-limiting illustrative examples of which will now be discussed.

In order for a user to participate in an auction, the user may need to have an account with the system or associated client, have a credit card or other payment information (e.g., a credit card, debit card, bank account number, expiration dates, etc.) on record that meets certain requirements (e.g., billing address within specified location, has an expiration date that occurs no sooner than a specified period after the auction close (e.g., 1 week)), live in a specified location (e.g., country or state in which event is to occur), and the issuing bank may need to verify and authorize the credit card.

The auction related information may further discuss how bids are to be submitted and how winning bidders are identified or selected by the system or otherwise. For example, a user may be instructed to select or enter the number of tickets the user wants to bid on via a ticket quantity field, to enter the corresponding bid amount (e.g., per ticket or for a set of tickets) via a bid field. The user may be instructed to enter a bid amount that is a multiple of a bid increment specified for the auction, wherein the bid is to be greater than or equal to a specified and displayed minimum bid. The user may then be instructed to select a “place bid” button or other control to submit the bid.

Information may be provided to the user regarding how bids are ranked (e.g., ranked first by the amount bid per ticket, with ties broken based on the time that the bids were placed with earlier bids receiving priority), how the user will be notified if the user is a winning bidder and/or a losing bidder (e.g., via email, SMS text message, MMS multimedia message, physical mail, etc.), and how the tickets will be delivered (e.g., via mail as a physical ticket, embedded into or attached to an email for printing, as a download from a website, as a barcode transmitted to a phone from which it may be scanned, as an electronic token stored in memory in a portable device, etc.). By way of further example, information may be provided regarding whether or not a user may be allowed to have more than one pending bid per auction, whether or not a user may rebid (e.g., wherein a user can rebid, but where the user needs to increase the quantity of tickets being bid for and/or the bid amount per ticket, and wherein the previous bid will no longer be valid, and whether or not a user may simply cancel a bid). In addition, limitations on the number of tickets a user can bid on, if any, may be identified (e.g., 2, 4, or 8 tickets for a given auction).

An example user interface for a fixed rate exchange will now be described. In an example fixed rate exchange, the user may be informed of the price of resource (e.g., ticket price for one or more categories of tickets), and if there are different quality resources being offered (e.g., different seating areas, sections, rows, etc.), the corresponding resources prices (e.g., ticket prices). Optionally, in the case of tickets for an assigned seating event (as opposed to a general admission event), the user may be informed which seats the user will be assigned if the tickets are purchased (e.g., seating section, row, and seat number). In addition, the user may be informed regarding limitations, if any, on the quantity which may be purchased. If, once a ticket is posted for sale the price will not be changed, optionally the user is so informed. If, once a ticket is posted for sale the price may be changed until an event occurs (e.g., until the user has placed a selected ticket in an electronic shopping cart and has completed the purchase process within a specified time thereafter), optionally the user is so informed.

In certain example situations, a seller may be able to ask any price for a ticket (optionally, subject a minimum and/or maximum price specified by an authorized entity), and is not restricted to a “face value” price. For example, a user interface may be provided which lists a variety of resources, such as tickets, offered at different prices by different sellers. Thus, thus two different sellers may be offering tickets for sale, wherein the two sellers happen to have tickets for seats right next to each other, but where the asking prices may be very different. If, once a ticket is posted for sale the price will not be changed, optionally the user is so informed. If, once a ticket is posted for sale the price may be changed until an event occurs, optionally the user is so informed. This distribution channel is also referred to as an unbounded fixed exchange rate channel.

The different characteristics of the distribution channels may render certain channels more suitable than others for a given resource. In certain situations, a seller may desire to maximize and/or enhance total revenues received for tickets sales for an event and/or for tickets sales and ancillaries (e.g., parking, concessions (e.g., food, clothing, programs, novelty items), etc.). Certain distributions channels may better achieve such goals for resources that are in high demand with limited availability (e.g., an auction in certain circumstances), while other channels (e.g., a fixed exchange rate sale in certain circumstances) may better achieve such goals for resources that are in low demand and/or that have an availability that will more than meet such demand. By way of further example, certain ticket distributions channels may better achieve such goals when there is a relatively short time (e.g., 1 week, 2 weeks, 4 weeks, or other time period that would be considered short for a given event) until the associated ticketed event occurs, while other ticket distributions channels may better achieve such goals when there is a relatively long time (e.g., 5 weeks, 6 weeks, 8 weeks, etc.) until the associated ticketed event occurs.

By way of further example, certain distributions channels (e.g., auctions) may better achieve such goals for resources where a large percentage (e.g., 10%-20%, 20%-30%, 40%-50%, or other specified percentage) of potential purchasers have authorized (e.g., via an account management web page hosted by the system) that notifications regarding tickets (e.g., ticket availability, auction updates, whether the user's bid is currently a winning or losing bid etc.) be transmitted to them (e.g., to their mobile phone, email account etc.), while other channels (e.g., a fixed exchange rate sale in certain circumstances) may better achieve such goals where a relatively low percentage (e.g., less than 10%, less than 20%, or other appropriate specified percentage) of potential purchasers have authorized that notifications regarding tickets be transmitted to them. Thus, for example, the system may take into account the quantity or percentage of potential purchasers/registered website users have requested notifications to be provided regarding a particular event, performer, or team.

By way of illustration, the characteristics discussed below may affect the suitability of a given channel for a given resource, such as a seat ticket for an event. The following characteristics relate to the amount of demand for a resource, the likely audience, the price sensitivity of the demand, the ability of users to access the distribution channels, the sophistication of the users, the ability to provide substantially real time information to users (e.g., to their phone, via email, etc.), the time frame in which the resources may be offered, and legal restrictions on resource offerings:

the event type(s) (e.g., rock concert, country music concert, jazz concert, classical concert, musical play, Broadway play, off-Broadway play, sporting event, movie, museum show, magic show, etc.);

number of available seats;

venue seat configuration;

price constraints (e.g., specified minimum and/or maximum allowable prices);

specified limits on the number of tickets a user can purchase;

the amount of time until the event;

the number and/or demographics of the likely audience and/or ticket purchasers (e.g., age (3-6 years old, 7-10 years old, 11-14 years old, 15-19 years old, 20-25 years old, 25-35 years old, 36-49 years old, 50-65 years old, 65-75 years old, older than 75 years old, or a combination of two or more of the foregoing age groups); income levels (e.g., number of potential/likely ticket purchasers having a yearly income of less than $25K, $25K-$49,999, $50K-$74,999, $75K-$99,999, $100K-$149,999, $150K-$249,999, $250K-$499,999, $500K or greater; the average income, the median income), gender breakdown (e.g., male %, female %), the number and/or percentage that have an Internet connection, the number and/or percentage with a broadband connection, the number and/or percentage of homeowners, the number and/or percentage of renters, the number and/or percentage with less than a high school diploma, with a high school diploma, with a two year college degree, with a four year college degree, with a graduate degree, etc.);

historical sales information for similar events (with the same or similar performers);

if the event is a musical event, dollar value/numbers for recent album/song sales of the performer (e.g., sales in the past 6 months, year, within the last two years, or other time period);

if the event is a sporting event, the team(s)' current standing, number of wins/losses, recent win/loss streak, whether the sporting event is a post season/playoff event or in close proximity to the post season/playoffs;

how recently and/or how often the performer has performed in the geographical area of interest;

the percentage/how many users have indicated (e.g., via a notification opt-in specific to the event performer/team and/or the event type, wherein the opt-in user interface is provided via a web page) that notifications related to ticket availability for the event are to be (optionally automatically) transmitted to them (e.g., via email, to cell phones via text messaging and/or multimedia messaging, etc.);

the existence of other competing events within the same time period (e.g., an important sporting event, such as a playoff game of a local team, events similar to the event at issue, etc.);

availability of resale markets where a ticket purchase can resell their tickets;

legal restrictions (e.g., restrictions that prohibit auctions for the ticket, that restrict how much can be charged for the ticket, that restrict who the ticket can be sold to, that restrict when the ticket can be offered for sale, etc.);

if ticket sales have already begun for the event via one or more channels, the number of tickets sold per channel, the sales percentage for those tickets that were offered (on a per channel basis), the ticket prices of those tickets offered for sale (including those tickets that were sold and/or those tickets that were not sold), and/or for auctions, the winning bid amounts.

Information regarding the foregoing characteristics may be stored in a local and/or remote system database and accessed for processing by the allocation system and/or for viewing by a human operator via a terminal. The allocations to the various channels can be automatically performed by the allocation system. Substantially real time sales data from one or more channels (optionally including resale channels) is used by an allocation software servo mechanism to reallocate tickets to the various distribution channels to achieve or to attempt to achieve desired sales/profitability goals and to comply with specified restrictions (e.g., restrictions that specify maximum and/or minimum tickets to be allocated to a given channel).

By way of illustration, if a significant percentage of the likely or potential ticket purchasers for an event have a relatively high income and a relatively high rate of notification opt-ins, it is likely that event tickets will sell for a relatively higher amount and that the potential purchasers may be relatively more willing to participate in an auction (as they can receive substantially real time updates as to whether they need to increase their bid in order to have a winning bid). In such a scenario, auctions may achieve higher sales, at least for a first type of tickets (e.g., the 100 or 500 seats closest to the stage).

Thus, if an event has 5000 seats, at least initially, a relatively large amount of tickets (e.g., 350 tickets for relatively high quality seats, such as seats in the first row, first five rows, or first ten rows) may be allocated to an auction distribution channel, and 1000 relatively lower quality seats may be sold at a continuous fixed exchange rate sale channel, wherein once an exchange rate is set for seat tickets for a given class of event seats, the exchange rate will not change for that class of event seats. If the auction achieves a desired level of ticket sales via the auction (e.g., where all or substantially all of the tickets allocated to the auction have been sold), additional tickets (e.g., an additional 500 tickets) for the event may be allocated to the auction distribution channel, and optionally, additional tickets may also be allocated to the continuous fixed exchange rate sale channel and to a fixed exchange rate sale channel wherein the ticket price can be higher than previously offered similar (e.g., in the same class) seat tickets for the event.

If the auction failed to achieve a desired level of ticket sales (e.g., where less than 90%, 75%, 50%, or other threshold were sold), optionally, no further event tickets will be allocated to the auction channel, and the remainder of the event tickets will be allocated to be sold via the continuous fixed exchange rate sale channel.

As similarly discussed above, pricing feedback data can be obtained via a presale auction and/or continuous smaller auctions that occur simultaneously with the sales cycle in the initial sale market. Optionally, if, for example, resources, such as tickets, are being allocated/sold via an auction, the rate of bids, the amount of bids, the bid increments, the number of available resources/tickets, the number of resources/tickets allocated/sold via other processes (e.g., via one or more fixed exchange rate processes), the system can determine (optionally in substantially real-time) if the amount of resources/tickets being allocated/sold via auction should be increased or decreased. Similarly, a determination is made as to whether more of fewer resources/tickets should be allocated/sold via one or more of the other processes.

For example, where resources, such as tickets are to be allocated via auctions or via a fixed exchange rate, an auction may be conducted to determine fixed exchange rate pricing, as similarly discussed above. If, in an auction, the bid amounts and/or number of bids meet or exceed corresponding first thresholds (indicating a high rate of demand), a determination may be made (e.g., automatically by the allocation system or manually by an operator) that additional resources are to be offered via the auction or via an additional auction, rather than via a fixed exchange rate sale.

If, during the auction discussed above, the bid amounts and/or number of bids meet or exceed corresponding second thresholds lower than the first thresholds discussed above, (indicating a relatively lower, but still high demand), a determination may be made (e.g., automatically by the allocation system or manually by an operator) that additional resources are to be offered via a set price sale at a relatively higher price than ticket previously sold at the set price sale but at a lower price than the maximum, median, or average winning auction bid.

By way of further example, if the number of tickets and/or the rate of ticket sales in a fixed exchange rate sale of event tickets reach or exceed a certain threshold (indicating a high demand for the event tickets), additional event tickets can be allocated to an auction sale, which may more likely to achieve higher prices for a given quantity of ticket sales.

Thus, the allocations of tickets to various allocations channels can be dynamically determined based on substantially real time, recent, and/or historical sales data obtained via one or more of the allocations channels.

The progression and/or results of a dynamically-priced ticket sale and/or the dynamic allocation of tickets via various distribution channels are tracked by the allocation system and the information is optionally provided to administrators and to those that have certain authorizations. The report can include the number of tickets sold to date and/or during certain periods (e.g., with a daily or weekly breakdown), the revenues received from the ticket sales to date and/or during certain periods, the average and/or median price of the sold tickets, how many tickets were sold via each distribution channel, the sales rate per channel, etc. The information can be provided via tables, graphs (e.g., bar graphs, histograms, pie charts, etc.), or otherwise. The report may also include data on sales performance of ancillaries, such as parking and concessions.

For example, the report can be printed out or displayed electronically and provided to an administrator, an event promoter, an event performer, a venue operator, and/or other authorized entities. This information may be used by the appropriate recipient to aid in determining and setting tickets prices for unsold tickets, for defining what seats should be placed in the same bid auction group (e.g., where the user designated which group the user is submitting a bid), which seats are to be placed in the same fixed price group (where all seat tickets in a given group that are offered via a continuous fixed exchange rate sale have the same price), sales formats, and marketing strategies for the event and/or for subsequent similar events and inventory sales.

The information can be provided in substantially real time as the data is received and/or reports can be generated and transmitted at specified periods (e.g., once a day, once a week, once a month) and/or upon the occurrence of certain events. For example, a report may be generated when certain sales goals have been met or have failed to be met (e.g., with respect to the number of tickets sold, the revenues received from the ticket sales, the average and/or median price of the sold tickets, the number of tickets sold for a given distribution channel, the rate of sales, etc.). The report can be distributed in hardcopy, via an email attachment, embedded in an email, via a Web page, or otherwise.

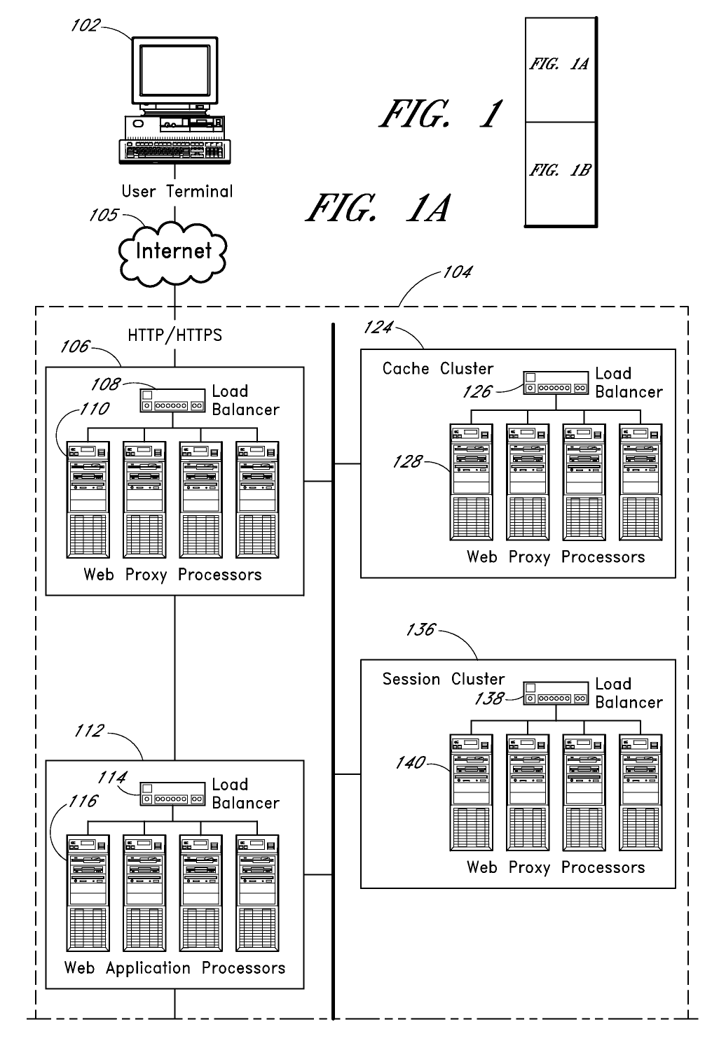

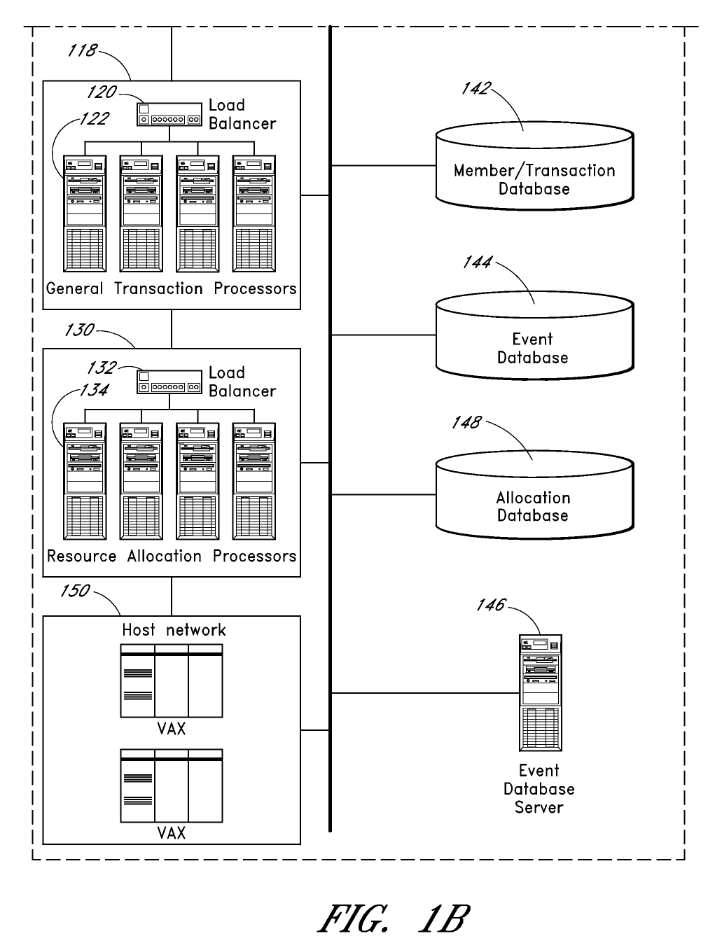

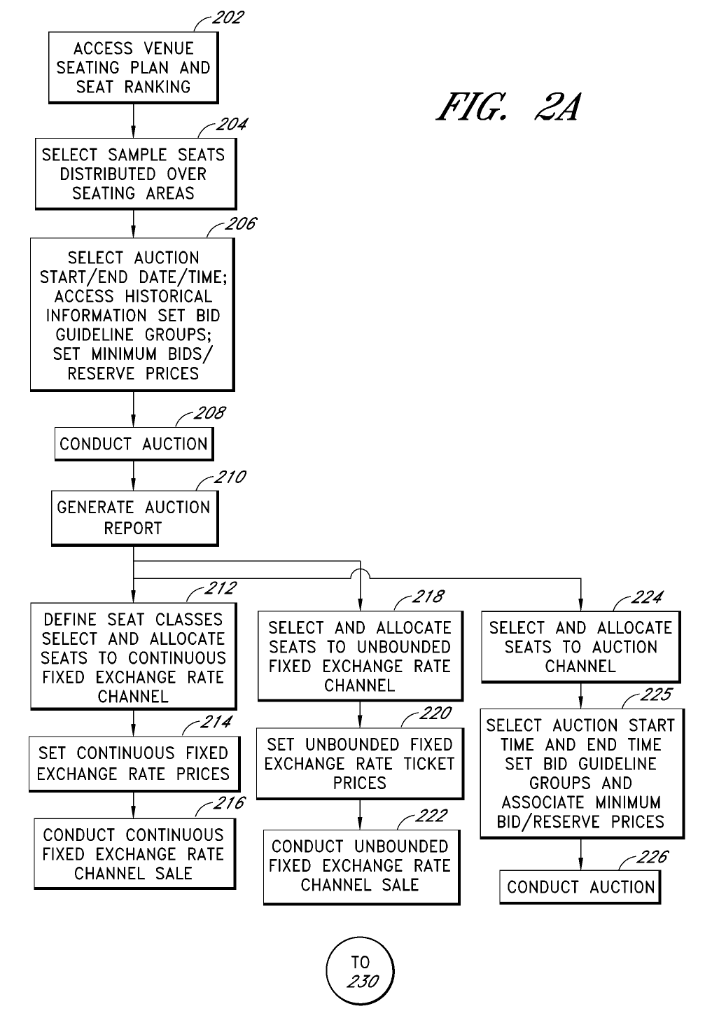

FIGS. 1A-B illustrates an example system embodiment that can be used in conjunction with the resource valuation and/or resource allocation processes described herein. Not all of the illustrated systems and components need to be included in the system and other systems and architectures can be used as well. With reference to FIGS. 1A-B, a user terminal 102 is coupled to an example resource valuation and allocation system (e.g., a ticketing system) 104 over the Internet 105 using a protocol, such as HTTP/HTTPS. By way of example, a user terminal can be in the form a of personal computer, a personal digital assistant, a smart phone having an operating system, a mobile or stationary phone, a networked television, a networked media server, etc. An example web proxy system 106 includes an optional load balancer 108 and web proxy processors 110, and can selectively block or route an inbound request from a user browser executing on the terminal 102 to an appropriate internal destination, which can be a queue or other destination server.

The illustrated example system 104 includes an example Web application system 112, which includes an optional load balancer 114 and Web application processors 116. A general transaction system 118 includes an optional load balancer 120 and transaction processors 122 that are used to generate transactional pages (such as some or all of the user interfaces described herein), populate data caches, provide logic and/or rules for the transaction flows, provide users with queue related messaging based on the queue position of a resource request, and to sequence requests. A cache cluster system 124 includes an optional load balancer 126 and processors 128. The cache cluster system 124 caches data and states for quick access by other system components.

An example processor system 130 is provided that includes an optional load balancer 132 and resource allocation processors 134. Optionally, the processors 134 can be used for a variety of types of sales and/or allocations, including, by way of illustration and not limitation, auctions, fixed/static price resource sales, and/or dynamic pricing of resources (e.g., the auction channel, continuous fixed exchange channel, dynamic-unbounded fixed exchange rate channels described below). The example processors 134 conduct and/or manage sales, keep track of resources or sets of resources being sold or otherwise allocated, the ownership history of resources (e.g., identification of the current holder and past holders), the status of sales, and in the case of auctions, the type of auction, the identity of current bidders, the current bid amounts, the minimum bid increments, the reserves, the current lowest bid prices needed to potentially win auctions, the number of resources in a set being auctioned off, and so on. Processor system 134 (or other system) optionally hosts a software servo system to adjust allocations to various distribution channels in substantially real-time using, for example, data on current and/or historical sales via one or more distribution channels.

The use of load balancers and multiple ticket sales processors can enable the sale/auction to continue, potentially with little or no performance impact, even if a system component (e.g., a processor 134) fails. For example, if a sales processor fails, processes that were performed by the failed processor are optionally directed via the load balancer to another sales processor. A session cluster system 136 includes an optional load balancer 138 and a plurality of processors 140 and is used to manage sessions.

A member transaction repository database 142 stores user contact information, billing information, preferences, account status, and the like, that can be accessed by other portions of the system 104. In addition, the database 142 can store an opt-in indication, wherein, with respect to auctions, the user has agreed to have their bid automatically increased by a certain amount and/or up to a maximum amount in order to attempt to ensure that they win a given auction. Optionally in addition or instead, the database 142 can store an opt-out indication. The database 142 can also store a user opt-in/opt-out for notifications regarding auctions, auction status, and/or change in the user's bid status from losing to winning bid or from winning to losing.

The database 142 can also store a user opt-in/opt-out for notifications regarding non-auctions, such as for notifications when resources are available via a fixed exchange rate allocation processes, exchange rates (e.g., prices) have been decreased in an exchange rate decay allocation, or when exchange rates have been increased, etc. Optionally, the database 142 stores a user indication that a user will purchase a resource (e.g., a ticket or right to select a seat for a given event for a given seating area (or areas)) if the resource price is at or below a specified amount, wherein if the resource price meets the user price criteria, the system automatically completes the purchase and charges the user. By way of example, the user can specify such purchase criteria via a web page hosted by the system 104.

Optionally, the database can store a user opt-in/opt-out for notifications regarding the release of additional resources (e.g., seat tickets for an event with a certain performer) of a type identified by user. For example, a notification can be transmitted to the user each time seat tickets are provided for sale or auction for a given event. Optionally, the opt-in can be limited to notifications for the release of seat tickets in selected venue areas or ticket price bands.

An event database 144 stores information regarding events, including, by way of example, the venue, artist/team, date, time, and the like. The event database 144, or a separate database, includes ticket information records, including one or more of barcode information, event name, event date, seat identifier, ticket holder name or other identifier of a current ticket holder, names or other identifiers of past holders of the ticket, a ticket valid/invalid indicator, and/or an indicator that as to whether the ticket has been used. An event database server 146 is used to provide event database access to other portions of the system. The event server 146 and/or other server can host a search engine that can be used to identify relevant events to a user. The search engine may identify such events in response to a user query (e.g., provided via the submission of search terms by the user), wherein the search engine identifies those events that match (or optionally, that partially match) the user query terms. The search results may be ordered or listed in order of the closeness of the match or in

An example database 148 is provided that stores one or more seller resource sales and information gathering rules. By way of example, the seller (or other authorized entity) can specify (e.g., via a user interface presented via a computer system, via oral instructions, via hardcopy instructions, or otherwise) whether and how many information gathering auctions are to be used to help set prices in a fixed exchange rate sale. Further, the seller can specify exact timing or approximate timings for the information gathering sales as well as the main fixed priced sale. The seller can also specify maximum and/or minimum number of seats that are to be offered for allocation via information gathering allocations and fixed exchange rate allocations. Further, the seller can specify that more than one type of fixed exchange rate sale can take place. For example, the seller can specify that certain tickets will be offered for sale at one or more set prices, wherein additional pricings will not be offered once the sale begins. The seller can specify that certain tickets will be offered for sale wherein the price may be adjusted upwards or downwards after being posted for same and/or wherein additional price levels can be established over the course of the sale.

For example, with respect to auctions, the sales rules can include auction rules (e.g., criteria for what a winning bid actually pays, what formula (s) are to be used in determining what a winning bid is to pay, when the auction will start, when the auction will end, etc.), auction operator rules, bidder eligibility criteria, information on the resources being auctioned, including a description, the reserve price (if any) the minimum bid price (if any), the minimum bid increment (if any), the maximum bid increment (if any), the quantity available, the maximum and/or minimum quantity of resources a given user can bid on (if any), the date the auction ends for the corresponding resources. The database can store the current bids, the current bid ranking, corresponding bidder identifiers, bid ranking criteria, resources categories, and/or the like.

By way of example, optionally the system may condition a user's eligibility to purchase or bid for resources, or specific resource group based on certain user or other characteristics, which may include, without limitation, whether the user has purchased or registered for a certain type of membership, the user's past purchase history with respect other items sold or offered for sale by the seller or a third party, where the user lives (for example, bidders may be required to be within a particular geographic region, within a particular governmental entity, such as a particular state or states, city or cities, zip code or zip codes, or within a certain distance from a given location, such as a venue or the like), and/or whether the user meets certain financial qualifications.

The database 148, or another database, can also store information regarding non-auction resource sales (e.g., ticket sales for an event), such as a presale beginning date, where selected users (e.g., members of one or more specified fan clubs, season ticket holders, holders of certain types of financial instruments, such as a credit card associated with a specified brand or issuer, frequent ticket buyers, etc.) can purchase resources at set prices before the general public can, a presale end date, an on sale beginning date, where the general public can purchase resources at set prices, an on sale end date, the maximum quantity of resources a user can purchase, and so on. With respect to a non-auction sale where the price of certain resources are adjusted during a sales period (e.g., wherein a ticket price is increased or decreased over the course of a ticket sales period to enhance total revenues), the database 148 can further store some or all of the following: information regarding a minimum resource sales price, a maximum resource sales price, a minimum dollar increment with respect to increasing a resource sales price, a minimum dollar decrement with respect to decreasing a resource sales price, a maximum dollar increment with respect to increasing a resource sales price, a maximum dollar decrement with respect to decreasing a resource sales price, the data and/or time when price increments or decrements are to take place, and a limit on the number of resource price changes within a specified period (e.g., no more than one price change every four hours, no more than one price change every twenty four hours, etc.).

A survey and historical information database 149 can also be provided that stores survey results from consumers related to, by way of example, resource pricing and ranking (e.g., ticket pricing and/or seat, area, or section ranking). In addition, the database 149 optionally includes historical sales information (e.g., rate of resource sales, such as the ticket sales per section or area for one or more historical events, total ticket sales per section for one or more historical events, rate of ticket sales per price band for one or more historical events, total ticket sales per price band for one or more historical events, etc.). The database 149 can also include actual/estimated cost and revenue data.

A host network system 150 is provided that stores bids (e.g., winning and optionally losing bids), event, sales, and auction set-up information, section and seat information (e.g., quality or ranking information), seat to bidder allocations in the case of auctions, and credit card processing.

The system can further include or be coupled to printers for printing hardcopy tickets, an email system for emailing or otherwise transmitting electronic tickets to purchasers/recipients (e.g., by transmitting a barcode or other code to a purchaser/recipient phone), and/or the system may be configured to download electronic tickets to a purchaser computer. The system may be further coupled to a turnstile and/or entry scanner. The system can receive scanned ticket data and determine whether a scanned ticket is valid for the event and for which seat/location within the event venue.

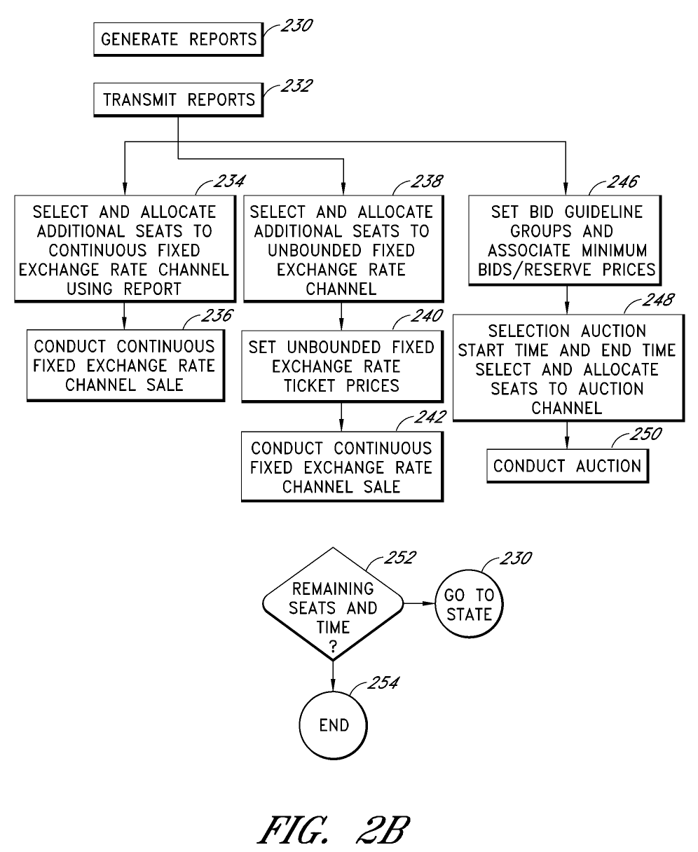

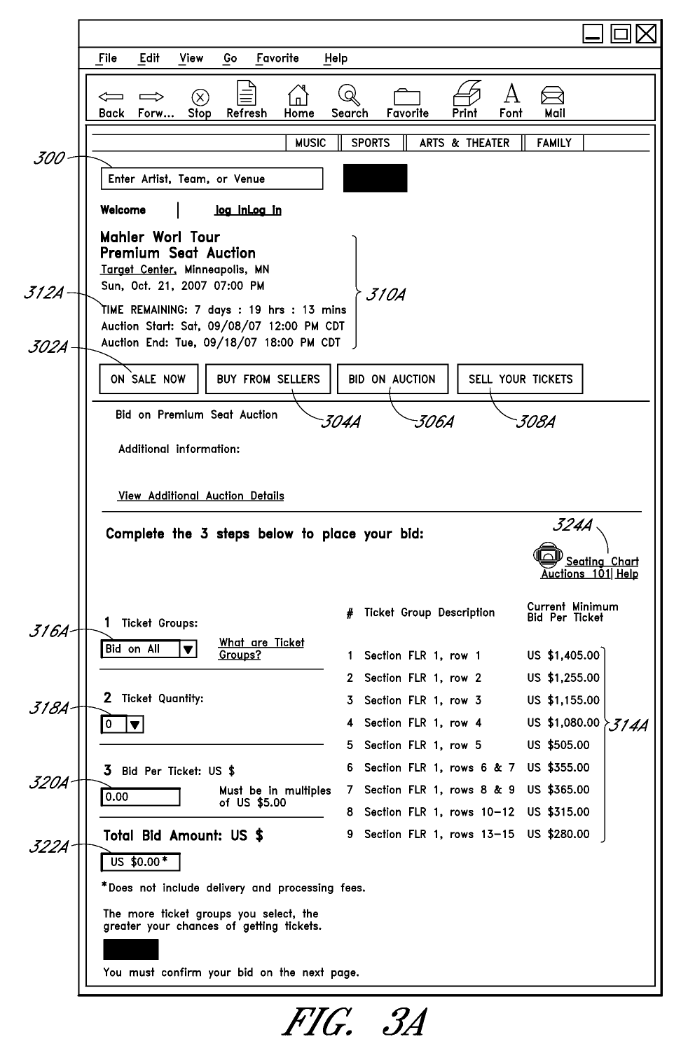

Referring now to FIGS. 2A-B, an example process for information gathering, dynamic allocation of seats to different distribution channels using the gathered information for an event, and for dynamic pricing for the event using the gathered information will be described. The process can be executed using the example system illustrated in FIGS. 1A-B.

At state 202, the system accesses from memory a venue seating plan and seat ranking for the venue at which the event is to take place. For example, the seating plan can define seating sections, the section rows, and the number of seats in the rows. A ranking can be stored in association with a corresponding seat. The ranking can indicate the quality of the seat relative to other seats as defined by an authorized entity (e.g., the venue operator, the ticket distributor, the promoter, and/or the performer). The information can optionally be displayed to a system operator. At state 204, the system and/or operator selects a distribution of seats to be auctioned in an information gathering process. In particular, the seats are selected so that the auction of such seats will provide valuation information for neighboring seats. For example, 2 seats may be auctioned per each row, or each second row, or each third, in each seating section, every other seating section, or otherwise. Certain seats may optionally be pre-designated for such information gathering sales. Certain seats may optionally be pre-designated so that they are not offered during such information gathering sales. The seats may be selected based in whole or in part using criteria discussed elsewhere herein.

At state 206, the system and/or operator selects an auction start date and end date. The start and/or end dates can be selected based on the event date and an estimate as to how long it will take to sell/distribute all the event tickets (or a selected portion thereof). For example, the estimate as to how long it will take to sell/distribute tickets and the start and/or end dates can be selected based on the number of venue seats being offered during the auction, the number of event seats that will be offered, the location of the offered seats, whether any price or concession discounts are available for the offered seats, the characteristics of potential ticket buyers, and/or the number and/or the types of channels that will be used to distribute seat tickets.

In addition, historical tickets sales for events with the same performer and/or for similar events with other performers can be accessed from the database and used to set minimum bids/reserves for the auction. For example, the historical ticket prices, percentage of tickets left unsold, and/or the rate of sale can be used to set minimum bids/reserve so that it will be equal to the lowest historical ticket price within a certain period (optionally adjusted for inflation) that achieved an acceptable percentage of unsold tickets (e.g., 5%, 10%, 15%, 20%, or other appropriate percentage).

At state 208, the auction is conducted. Bids are received, minimum bids are raised accordingly, and at the close of auction, winning bidders are determined based on the bid amounts and the number of tickets being auctioned, although other criteria can be used as well or instead in determining a winning bidder. The seat tickets are allocated in accordance with the winning bid amounts and optionally the seat rankings (e.g., in the case of a reserved seat event), with ties broken based on the time bids were received and/or using other criteria.

At state 210, the bid amounts, the rate of bids, and the number of bids are tracked (optionally in substantially real time) and end of auction reports are generated and provided to the appropriate entities (e.g., a ticket system operator, a promoter, a venue operator, a performer, etc.). Optionally, the substantially real time auction data is reported to some or all of the appropriate entities as well.

As discussed in greater detail below, the reported information can then be used by the system and/or authorized human entity to allocate seat tickets to various ticket distribution channels (e.g., based on the demand indicated by the auction results and the amount bidders were willing to pay or bid for the tickets), optionally using a servo loop, such as described elsewhere herein. The allocations are optionally constrained by limits on the minimum and/or maximum number of seats and/or specified venue areas for which tickets are to be offered during a given ticket offering via a given channel (e.g., a seller may specify that at least 30% of the seats and no more than 66% of the seats are to be offered during the initial continuous fixed price ticket sale). Optionally, the allocations may be performed so as to reduce the number of purchase requests during a later offering, to thereby better distribute loads on the system.

Optionally, not all the remaining tickets are allocated at this time. Instead, a portion of the tickets can be held back, and allocated at a later time as additional sales information is obtained (e.g., for the already allocated tickets).

In particular, at state 212, the appropriate number of seats are allocated to a continuous fixed exchange rate distribution channel. Seat classes for the continuous fixed exchange rate distribution channel are defined, wherein tickets for seats in a given class are assigned the same ticket price. The allocated seats are assigned to the appropriate corresponding class.

At state 214, fixed prices are assigned to corresponding defined seat classes based on the report information and optionally historical ticket price and sales information from prior events. The start and optionally the end time of the continuous fixed exchange rate channel are set. At state 216, the continuous fixed exchange rate sale is conducted. Users can identify from which seat class they want to purchase a ticket from (or a user can ask for the best available seat, regardless as to which seat class it belongs to), and how many tickets they want to purchase. The system can search for and locate the available seat tickets corresponding to the selected seat class(es). The system can transmit seat ticket information corresponding to the located seat tickets to the user, and the user can decide whether or not to purchase the located tickets (e.g., by activating a purchase control if the user wants to purchase information and by providing payment information/authorization). If the user indicates that the user wants to purchase the tickets, the system processes the ticket purchase (assuming the user provides an adequate funding source), and the tickets are delivered to the user (e.g., by printing the tickets and distributing them via mail, or by transmitting or downloading electronic tickets/tokens via email, to a cell phone, to a smart card, or otherwise).

At state 218, seats are allocated to an unbounded fixed exchange rate channel (wherein seat tickets comparable to those in a class in the continuous fixed exchange rate can be different in price and optionally can have their price changed prior to purchase). At state 220, ticket prices are assigned to the allocated tickets based on information obtained from the reports and optionally historical ticket price and sales information from prior events. The start and optionally the end time of the unbounded fixed exchange rate channel are set. At 222, the unbounded fixed exchange rate sale is conducted. A user can view all of the available tickets and/or can specify seating areas or price ranges that are interest to the user, and the system will search for and identify certain or all tickets that match such criteria. The user can then purchase the identified tickets or optionally ask for other matching tickets to be identified. The system processes the ticket purchase (assuming the user provides an adequate funding source), and the tickets are delivered to the user.

At state 224, seats are manually or automatically allocated to an auction channel and to bid guideline groups. Corresponding minimum bids/reserve prices are set. At state 225, an auction start time and end time are set. For example, the auction can be scheduled to begin and end before one or both of the other channels, the auction can be scheduled to begin and end after one or both of the other channels, or the auction can be scheduled to after and end after one or both of the other channels. At state 226, the auction is conducted. Bids are received, winners are determined, and tickets are allocated and delivered to the winners.

At state 230, one or more reports are generated for one or more of distribution channels. The reports can be used to perform additional seat allocations to one or more of the distribution channels, to set prices in the unbounded fixed exchange rate channel, and define bid guideline groups and minimum bids/reserve prices for the auction channel.

For example, with respect to the auction data, bid data, including the bid amounts, the number of bids, the number of winning bids, the winning bid amounts, statistical averages and/or medians thereof, and/or the number of unsold tickets can be reported. With respect to the continuous fixed exchange rate channel and the unbounded fixed exchange rage channel, the number of ticket sold, the price of the sold tickets, the seat locations corresponding to the sold and/or unsold tickets, the rate of the tickets sales, and/or the number of unsold tickets can be reported. Optionally, sales performance of ancillaries, such as parking and concessions, during one or more of the channels' sales can be collected and reported in substantially real time.

At state 232, the reports can be transmitted to one or more recipients (e.g., a performer, a promoter, a venue operator, a ticket seller, etc.).

At state 234, if appropriate, additional seats are selected are allocated to the continuous fixed exchange rate channel using the report information and optionally historical sales information from other similar events. At state 236, the continuous fixed exchange rate channel sale is conducted as similarly discussed above.

At state 238, if appropriate, additional seats are selected are allocated to the unbounded fixed exchange rate channel using the report information and optionally historical sales information from other events. At state 240, tickets prices are set for the allocated seats using the report information and optionally historical sales information from other events. At state 242, the unbounded fixed exchange rate channel sale is conducted as similarly discussed above.

At states 246 and 248, bid guideline groups are defined, minimum reserve prices/minimum bid amounts are set, an auction start time and end item are set, and, if appropriate, additional seats are selected are allocated to the auction channel using the report information and optionally historical sales information from other events. At state 250, the auction is conducted as similarly discussed above.

At state 252, a determination is made as to whether there are seat tickets still unsold and time enough to conduct additional sales via one or more channels. If there are remaining seats and time, the process proceeds back to state 230, and the reporting and allocation process is again performed. Otherwise, the process ends at state 254.

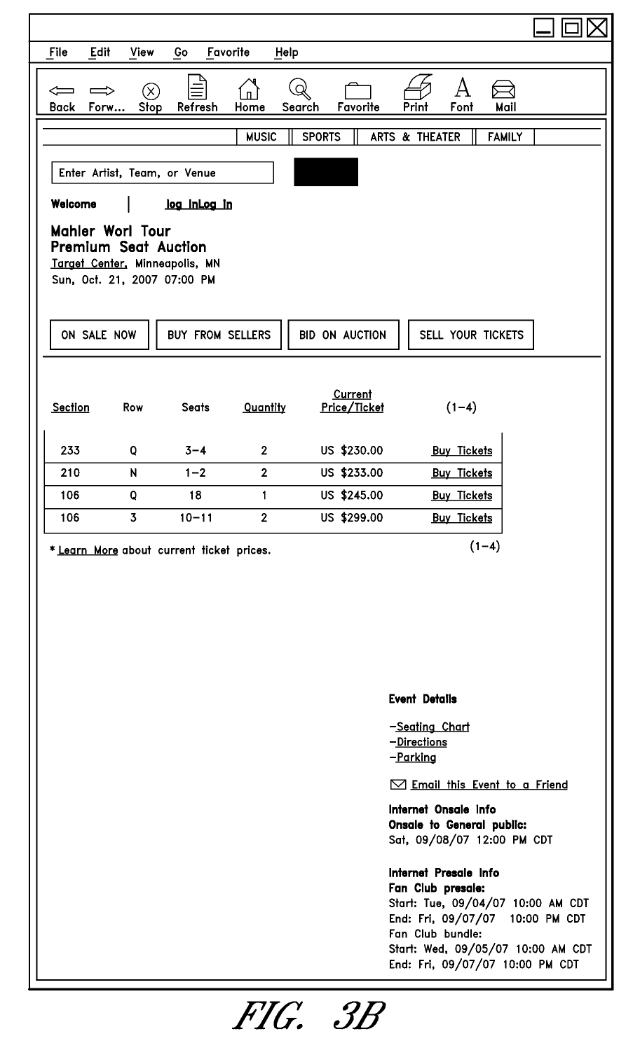

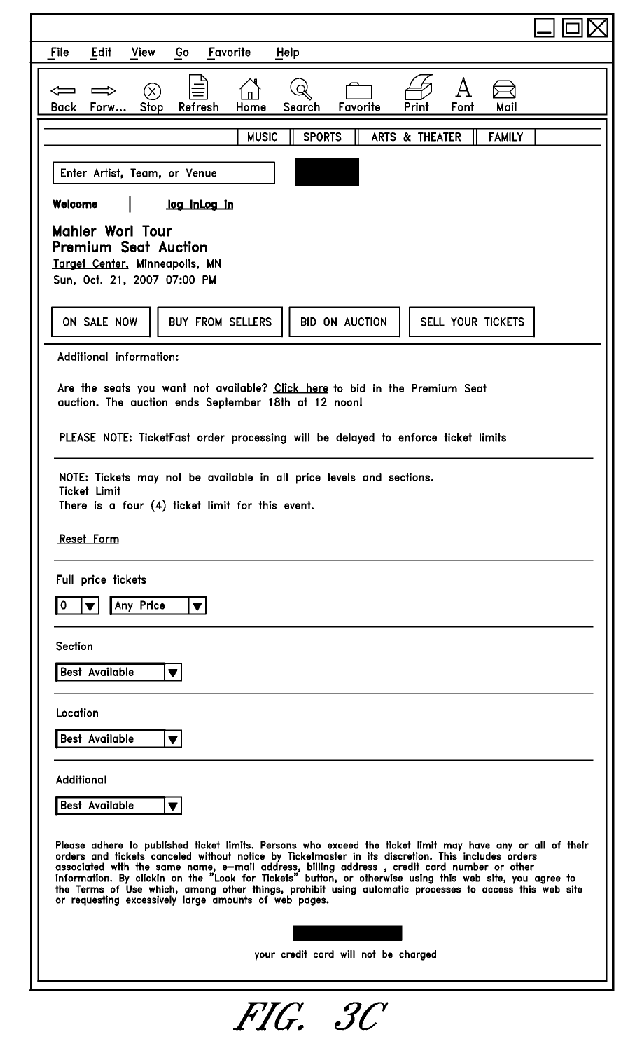

FIG. 3A illustrates an example channel selection interface for an event. In this example, each channel is associated with a tab. The example tabs include an “on sale” tab 302A that corresponds to and provides access to the continuous fixed exchange rate channel. A “buy from multiple sellers” tab 304A is provides corresponds to and provides access to the unbounded fixed exchange rate channel, where, in this example, the ticket distributor, the performer, the promoter, resellers, and/or other authorized entities can sell tickets at optionally differing prices for similar event seats (optionally, rather than multiple seller, only seller can be offering tickets for sale via this channel). A “bid on auction” tab corresponds to and provides access to an auction channel. A “sell your tickets” tab provides access to a user interface (not shown) via which a user can place one or more tickets purchased by the user up for sale. The number and types of tabs can vary based on the current date/time and on the event. For example, if only an auction channel is available (e.g., where an information collection auction is run prior allowing tickets to be allocated using other channels), optionally, other tabs will not be displayed.

FIG. 3A further illustrates an example auction user interface. The event name, venue, date and time are listed in area 310A. An auction start date/time and end date/time are listed as well. The user interface displays the remaining time 312A until the end of the auction. The tickets may be offered via the auction by the ticket distributor, venue, performer, or other authorized entity.

Optionally, there may be more than one ticket group for which a user can submit bids. A ticket group optionally consists of tickets with similar characteristics (e.g., the tickets are in certain rows, or the tickets are in a certain section). Optionally, when there is more than ticket group, a user can submit bids for seats in one or more ticket groups. In the illustrated example, there are nine ticket groups 314A, although fewer or more ticket groups can be used. Minimum bids are listed for each ticket group.

In the illustrated example, the user, via the ticket group drop down menu 316A, can indicate that the user wants to bid on all ticket groups, groups 1-5, groups 1-4, groups 1-3, groups 1-2, or other combination or permutation of ticket groups. In an example embodiment, if a user places a valid winning bid it will fall into one of the user selected ticket groups. The bid will remain in a ticket group until it is ranked lower than all valid winning bids in that ticket group, and then the bid will fall into the next, lower quality ticket group that had been selected by the user. If it falls out of the last user selected ticket group, the user's bid will then be a losing bid.

Optionally, a communication (e.g., an email, an SMS message, an MMS message, an instant message, and/or other form of communication) is transmitted to the user in substantially real time when the user's bid becomes a losing bid. The user can then elect to increase the bid so that it is no longer a losing bid. Optionally, bids are ranked first by the amount bid per ticket, with ties broken based on the time that the bids were placed, with earlier bids receiving priority. Optionally, proxy bidding may be provided, wherein the user bids the maximum the user is willing to pay for an item. An automatic bidding system then bids the lowest possible amount to make the user a winning bidder, so long as that lowest amount does not exceed the user specified maximum. If the user is outbid (so that the user's current bid is a losing bid), the automatic system will keep raising the user's bid to ensure the user has a winning bid, or until the user specified maximum is reached. This makes it possible for the user to win an auction while not online.

A user can specify how many tickets the user wants to bid via drop down menu 318A on and the amount of the bid via field 320A. Optionally, the user is required to place bids in multiples of a specified amount. The system automatically totals the bid amounts and displays it to the user via field 322A. Optionally, a bidder may be prevented from withdrawing a bid. The illustrated user interface includes a link 324A to a seating chart for the event venue.

A search field 300 is provided via which a user can submit search terms (e.g., the name of a performer/team, venue, city name, zip code, date(s), keywords, etc.) related an event that the user wants the system to identify.

FIG. 3B illustrates an example user interface for the unbounded fixed exchange rate channel, wherein tickets can be purchased for the offering prices, and wherein offering prices for similar quality seats do not have to be the same. A listing of available seats 302B is provided. A given listing entry identifies the seating area (e.g., by section, row, and seat number), the quantity of seat tickets being offered, and the current price per ticket (or per group of tickets). Optionally, the seller for a given listing is displayed. In this example, the listing is sortable by section, row, quantity, and/or price. Clicking on a “buy tickets” link for a given entry causes a ticket purchase user interface to be presented.

FIG. 3C illustrates a user interface corresponding to the continuous fixed exchange rate channel. A quantity field 302C is provided via which the user can specify the desired number of desired seat tickets. A price field 304C is provided via which the user can select or specify an acceptable ticket maximum price or price range. Section and location fields 306C are provided via which the user can specify a desired seating location.

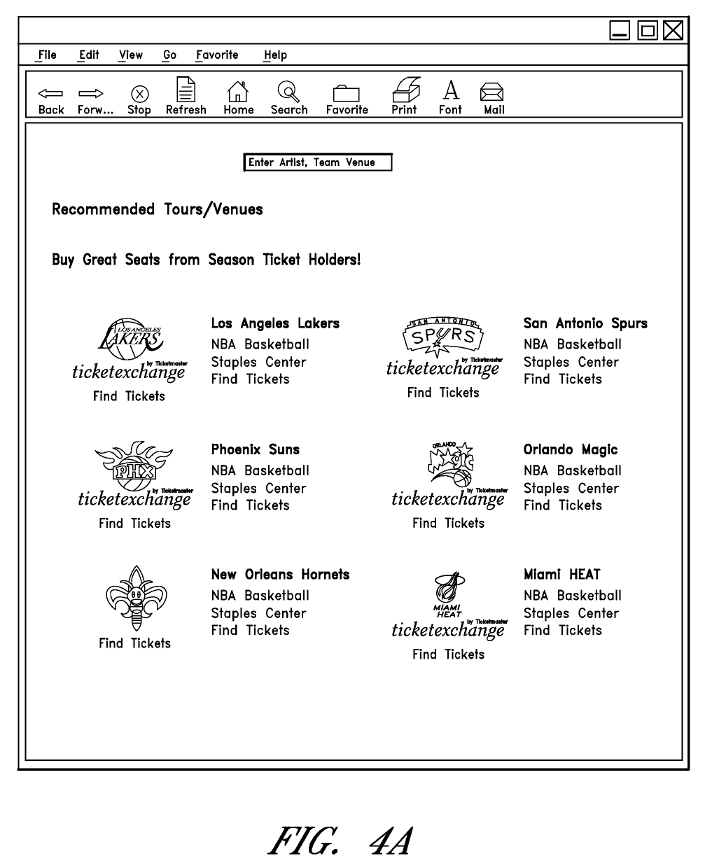

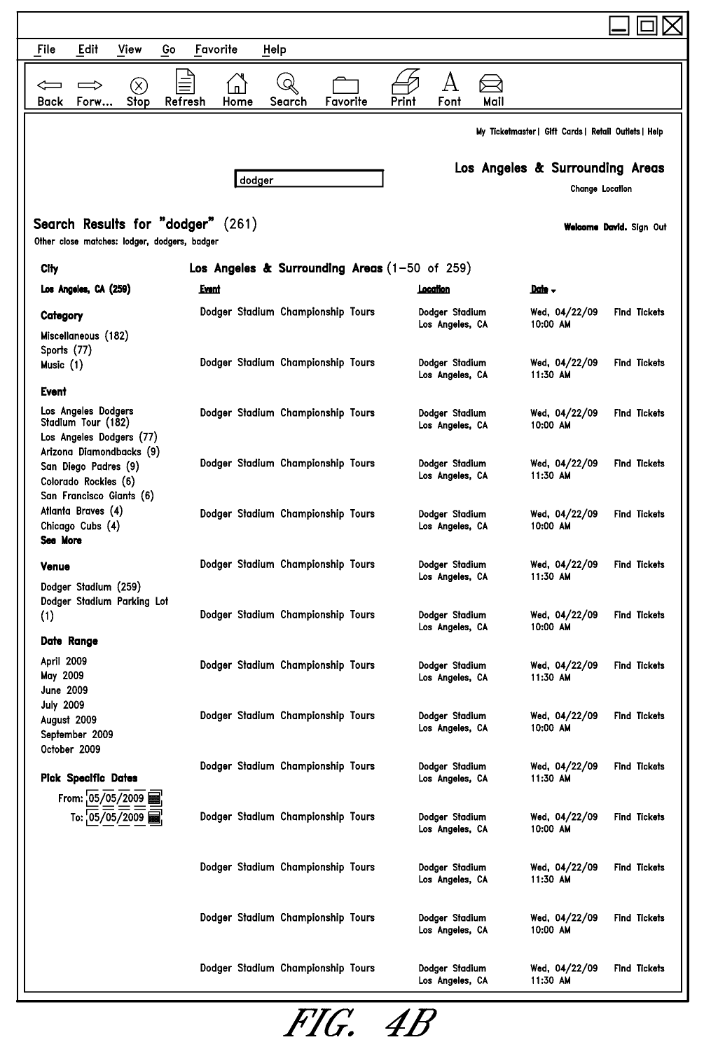

FIG. 4A illustrates an example unbounded fixed rate exchange search and browse user interface that can be presented to the user via a browser hosted on a user terminal. A listing of events for which tickets are being offered in the unbounded fixed rate exchange channel. A search field is provided via which a user can enter an artist, team, venue, and/or keyword. The search is optionally limited to a geographical area (e.g., the geographical area of the user) and/or to a specified range of time. At least partly in response to the user activating the search control, the search query is transmitted to the ticket distribution system, the system will search its database and/or other relevant databases to identify matching event. The matching events will then be transmitted to the user's terminal for display to the user. The search results may be ordered so that the closest matches are presented first or by date. FIG. 4B illustrates an example search results listing ordered by date.

Thus, methods and systems are described herein that optionally measure the progression and/or results of a dynamically-priced ticket sale and generate reports regarding the same to one or more interested parties. The reports may also include data on sales performance of ancillaries, such as parking and concessions. Some or all of the foregoing information is optionally used in determining ticket prices, bid guideline group definitions for auctions, distribution formats and channels, and marketing strategies for subsequent events and inventory sales.

Thus, an example embodiment provides a method of collecting data over a network from a plurality of sources, the method comprising: conducting a first information gathering sale of tickets for a first event including receiving over the network at a data collection system ticket sale information, wherein the ticket sale information includes sales quantities and sales prices for tickets sold during the first information gathering sale, and wherein the prices for tickets are determined at least in part by ticket buyers; storing sales quantities and sales prices for tickets sold during the first information gathering sale; and using information gathered via the first information gathering sale to determine at least in part ticket allocations to a first sales channel having fixed prices for tickets being offered for sale, and to determine at least in part ticket allocations to a second sales channel wherein prices for tickets being offered for sale are changeable. Optionally, at least a portion of the prices for tickets being offered via the second channel are above corresponding face values of the tickets. Optionally, the first information gathering sale is an auction. Optionally, the first information gathering sale is a fixed price sale.

An example embodiment provides a method of allocating resources, the method comprising some or all of the following acts: allocating a first subset of resources to a first auction distribution channel, wherein a first allocation specification corresponding to the first subset is stored in memory; causing, at least in part, information regarding the first auction distribution channel to be transmitted over a data network to user terminals; storing information related to how many winning bids were received for resources in the first set of resources in computer readable memory; storing information related to exchange rates associated with the winning bids for resources in the first set of resources in computer readable memory; based at least in part on the winning bid related information, allocating a second subset of resources to a first fixed exchange rate distribution channel and storing a corresponding second subset allocation; based at least in part on information related to exchange rates associated with the winning bids for resources in the first set of resources, setting one or more fixed exchange rates to be used in association with the first fixed exchange rate distribution channel and storing the one or more fixed exchange rates in memory; allocating a third subset of resources to a second auction distribution channel and storing a corresponding third subset allocation specification; causing, at least in part, information regarding the second auction distribution channel to be transmitted over the data network to user terminals; storing information related to how many winning bids were received for resources in the third set of resources in computer readable memory; storing information related to exchange rates associated with the winning bids with respect to the third set of resources in computer readable memory; and based at least in part on the winning bid related information for the third set of resources, allocating a fourth subset of resources to at least one distribution channel and storing a corresponding fourth subset allocation specification; based at least in part on information related to exchange rates associated with the winning bids for the third set of resources, setting and storing in memory one or more fixed exchange rates, to be used in association with at least one fixed exchange rate distribution channel.

Optionally, the exchange rate for at least one distribution channel is set based at least in part on how many remaining resources of a first type are available for allocation. Optionally, timing associated with at least one distribution channel is based at least in part on a minimum pre-specified interval between initiation of distribution channels. Optionally, an exchange rate for a first plurality of resources that is to be distributed via at least one of the distribution channels is set based at least in part on: a specified maximum exchange rate; and a specified minimum exchange rate, wherein the specified maximum exchange rate and the specified minimum exchange rate are different. Optionally, an exchange rate for a first plurality of resources that is to be distributed via at least one of the distribution channels is set based at least in part on a: a specified maximum permissible exchange rate adjustment increment; and a specified minimum permissible exchange rate adjustment increment. Optionally, the number of resources allocated to the first auction distribution channel is limited to a pre-specified maximum permissible number of resources that are to be allocated using the first auction distribution channel, wherein the pre-specified maximum is less than all available resources and wherein less than the pre-specified maximum can be allocated to the first auction distribution channel. Optionally, the first subset of resources includes tickets associated with seats, and wherein at least a portion of the seats are in different rows, wherein only a portion of a seats for a first row are associated with tickets in the first subset of resources.

In an example embodiment, a computer system, comprises: program code, which when executed is configured to provide a user interface configured to receive a user search query; a search engine configured to receive the user query and to identify one or more events corresponding to the user search query; program code, which when executed is configured to provide a user interface configured to display at least a portion of the identified events to the user and to receive a user selection of a first of the identified events; program code, which when executed is configured to provide a user interface configured to display fields for requesting a ticket for the first event, wherein a user can specify an acceptable exchange rate regarding the ticket; a data store configured to store ticket requests received from a plurality of users for the first event, including corresponding acceptable exchange rates, and request timing; a servo system configured to be to suggest allocations of tickets for the first event with respect to at least two different distribution channels based at least in part on the number of ticket requests, exchange rate data, and request timing data; and a data store configured to store an indication as to how event tickets are to be allocated to the at least two different distribution channels. Optionally, at least a portion of the tickets acquired via the at least two different distribution channels are transmitted electronically to users (e.g., via email, SMS message, MMS message, as a download, to a smart card, to a phone, and/or otherwise).

An example embodiment provides a method of allocating resources, the method comprising some or all of the following: using a resource allocation computer system to measure the progression and/or results of a first dynamically-priced ticket sale of a first set of tickets for an event, the first dynamically-priced ticket sale performed at least in part prior to the offer for sale of a second set of tickets via a fixed price sale; based at least in part on information related to the progression and/or results of the first dynamically-priced ticket sale of the first set of tickets: assigning a number of tickets to be included in the second set of tickets, the second set of tickets including a first subset of tickets at a first fixed ticket price, and a second subset of tickets at a second fixed ticket price; storing in computer readable memory an indication as to which tickets are in the first subset and the corresponding first fixed ticket price; storing in computer readable memory an indication as to which tickets are in the second subset and the corresponding second fixed ticket price; storing in computer readable memory sales information related to the second set of tickets; using the computer system to measure the progression and/or results of a second dynamically-priced ticket sale of a third set of tickets for an event, the second dynamically-priced ticket sale performed at least in part after the offer for sale of the second set of tickets via a fixed price sale; and based at least in part on information related to the progression and/or results of the second dynamically-priced ticket sale of the second set of tickets, assigning a number of tickets to be offered for sale at a third fixed price. The method optionally further comprises selling over a network a first ticket of similar quality to that of a ticket in the first subset at a price different than the first fixed ticket price via a non-auction sales channel, wherein the non-auction sales channel is configured to sell tickets from multiple sellers at prices correspondingly set at least in part by the multiple sellers. Optionally, the act of assigning the number of tickets to be included in the second set of tickets is based at least in part on the information related to: the progression of the first dynamically-priced ticket sale; and/or on the results of the first dynamically-priced ticket sale. Optionally, the act of assigning the number of tickets to be included in the second set of tickets is based at least in part on the information related to the progression of the first dynamically-priced ticket sale, including the rate of sales for at least a first time period. Optionally, the act of assigning the number of tickets to be included in the second set of tickets is based at least in part on the information related to the progression of the first dynamically-priced ticket sale, including the distribution of sales during the first dynamically-priced ticket sale. Optionally, the first fixed ticket price is assigned based at least in part on bid amounts in the first dynamically-priced ticket sale. Optionally, the first fixed ticket price is assigned based at least in part on information related to how many bids were received in the first dynamically-priced ticket sale. Optionally, the first fixed ticket price is assigned based at least the average or mean of winning bids received in the first dynamically-priced ticket sale. Optionally, a first bid group and a second bid group are defined for the second dynamically-priced ticket sale based at least in part on sales information for the second set of tickets, wherein the first bid group is associated with a different minimum bid than the second bid group. Optionally, the quality of seats associated with the first bid group is higher then the quality of seats associated with the second bid group. Optionally, a start time is selected for the second dynamically-priced ticket sale based at least in part on sales information of the second set of tickets.

In an example embodiment, a system is provided that automatically distributes in real time data collected via a plurality of remote terminals, comprising some or all of the following components: a data store configured to store information related to resource requests for dynamically valued resources received from remote terminals, wherein the information includes a resource selection, a resource quantity, and a resource value indication; and program code stored in computer readable memory configured to: automatically transmit to a remote computer system in substantially real a communication that includes information related to: how many resource requests have been received; a resource request rate; which resources have been requested; resource value indications; and receive and store in computer readable memory an indication as to which distribution channels additional resources are to be allocated. Optionally, the program code is configured to generate and transmit an updated communication in substantially real time, the update communication including changes in how many resource requests have been received. Optionally, the program code is configured to conduct a resource allocation process with dynamic pricing. Optionally, the communication includes an indication as to how many resources have been allocated during a first specified period. Optionally, the communication includes an indication as to revenues received from resource allocations. Optionally, the program code is configured to calculate an average and/or median price of resources sold during a distribution of resources associated with dynamic pricing. Optionally, the program code is configured to receive an indication as to how many resources were allocated for statically valued resources and determine an associated sales rate. Optionally, the program code is configured to receive an indication as to how many ancillary resources were allocated and to include related information in the communication. Optionally, the ancillary resources include parking and/or concessions. Optionally, the communication includes a table and/or graph. Optionally, the program code is configured to store resource prices for a future resource allocation.

An example embodiment provides a system for automatically distributing data collected via a plurality of remote terminals, comprising: a data store configured to store bid information related to auction bids for tickets for an event, wherein the bid information includes an auction identifier, a ticket quantity, and a bid amount; and program code stored in computer readable memory configured to: generate a transmission that includes information related to: how many bids have been received, a bid rate, which types of tickets have been bid for, bid amounts. The system is configured to transmit the transmission to a first designated recipient, receive an indication as to which distribution channels additional tickets are to be allocated, and store the indication in the data store.

An example embodiment provides a method of collecting and distributing data, comprising: receiving over a network bid information related to auction bids for tickets for a first event, wherein the bid information includes an auction identifier, a ticket quantity, and a bid amount; generating a transmission that includes information related to: how many bids have been received, a bid rate, which types of tickets have been bid for, bid amounts, transmitting the transmission to a designated recipient, receiving an indication from the designated recipient instructions for tickets to a second event, enabling sales for tickets for the second event to be conducted in accordance with the instructions.

Thus, as discussed above, certain embodiments use data from a first distribution channel (e.g., a presale auction and/or continuous relatively small auctions that occur simultaneously with a sales cycle in the initial sale of tickets to the event) to determine the manner, timing, rate, and/or pace of future ticket distributions and pricing (e.g., for an initial sale of a ticket by a promoter or other entity). The management of ticket sales (e.g., to reduce inventory risks and increase revenue) is thereby enhanced.

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than ticketing systems.

What is claimed is:

1. A computer system, comprising:
a web proxy system, including a load balancer and web proxy processors, wherein the web proxy system is configured to selectively block or route inbound requests from remote terminals to a selected destination;
a queue configured to receive requests from the web proxy system;
a transaction system including a load balancer and transaction processors configured to generate transactional pages, populate data caches, provide logic and/or rules for the transaction flows, transmit queue related messaging;
a cache cluster system including a load balancer and cluster system processors, wherein the cache cluster system is configured to cache data and states for access by other computer system components;
an interface configured to receive a user search query;
a search engine configured to receive the user query and to identify one or more events corresponding to the user search query;
program code that when executed causes the computer system to:
access one or more Websites hosted by one or more different computer systems;
examine information posted on the one or more Websites;
identify data included in the information that indicates exchange rates associated with tickets for the first event;
provide a user interface configured to present at least a portion of the identified events to the user and to receive a user selection of a first of the identified events;
provide user interface configured to present fields for requesting a ticket for the first event, wherein a user can specify an acceptable exchange rate regarding the ticket;
a data store configured to store ticket requests received from a plurality of users for the first event, including corresponding acceptable exchange rates, and request timing;
a servo system configured to suggest allocations of tickets for the first event with respect to at least two different distribution channels based at least in part on the number of ticket requests, exchange rate data, request timing data and the identified data;
a data store configured to store an indication as to how event tickets are to be allocated to the at least two different distribution channels; and
program code that when executed issues at least a portion of tickets acquired via the two different distribution channels electronically.

2. The computer system as defined in claim 1, wherein the allocation suggestion is based at least in part on anticipated system load.

3. A computer system, comprising:
a user interface configured to receive a user search query;
a search engine configured to receive the user query and to identify one or more events corresponding to the user search query;
program code that when executed provides:
a user interface configured to present at least a portion of the identified events to the user and to receive a user selection of a first of the identified events;
a user interface configured to present fields for requesting a ticket for the first event, wherein a user can specify an acceptable exchange rate regarding the ticket;
a data store configured to store ticket requests received from a plurality of users for the first event, including corresponding acceptable exchange rates, and request timing;
a servo system configured to suggest allocations of tickets for the first event with respect to at least two different distribution channels based at least in part on the number of ticket requests, exchange rate data, and request timing data;
a data store configured to store an indication as to how event tickets are to be allocated to the at least two different distribution channels; and
program code that when executed issues at least a portion of tickets acquired via the two different distribution channels electronically.

4. The computer system as defined in claim 3, further comprising program code stored in computer readable memory that when executed causes to the computer system to:
access one or more Websites hosted by one or more different computer systems;
examine information posted on the one or more Websites; and
identify data included in the information that indicates asking and/or sales prices associated with tickets for the first event.

5. The computer system as defined in claim 4, wherein the program code is configured to suggest ticket allocations at least partly based on the identified data.

6. The computer system as defined in claim 3, wherein the servo system is configured to suggest prices for at least a portion of the allocated tickets.

7. The computer system as defined in claim 3, wherein the allocation suggestion is based at least in part on anticipated system load.

8. The computer system as defined in claim 3, further comprising program code stored in computer readable memory that when executed causes to the computer system to:
determine a ticket request rate based at least in part on the request timing data,
wherein the allocation suggestion is in part on the ticket request rate.

9. The computer system as defined in claim 3, wherein the program code is configured to initiate offerings of allocated first event tickets via a second channel after offerings of allocated first event tickets via a first channel has ended.

10. The computer system as defined in claim 3, wherein the two distribution channels include a dynamic pricing channel and a non-dynamic pricing channel.

11. The computer system as defined in claim 3, wherein the two distribution channels include an auction channel and a fixed price channel.

12. The computer system as defined in claim 3, wherein the two channels include an auction channel and a channel via which a plurality of sellers can sell tickets to the first event.

13. The computer system as defined in claim 3, wherein the two channels include a fixed price channel, wherein once tickets are offered at a specified price, the price will not be increased, and a channel wherein tickets are offered at a specified price, but the seller has the option to increase the price prior to sale.

14. A computer system including a search engine, comprising:
program code stored in computer readable memory, that when executed is configured to provide an interface configured to receive a user search query;
a search engine configured to receive the user query and to identify one or more events corresponding to the user search query;
program code stored in computer readable memory, that when executed is configured to:
provide an interface configured to present at least a portion of the identified events to the user and to receive a user selection of a first of the identified events;
provide an interface configured to display fields for requesting a ticket for the first event, wherein a user can specify an acceptable exchange rate regarding the ticket;
a data store configured to store ticket requests received via a first distribution channel from a plurality of users for the first event, including corresponding acceptable exchange rates, and request timing;
an interface configured to provide information related to the plurality of ticket requests for the first event received via the first distribution channel, including information related to the ticket requests and acceptable exchange rates, wherein the information is configured to be used to determine, at least in part, allocations of tickets for the first event to at least two different distribution channels for the first event associated with different pricing techniques and to determine exchange rates for at least a portion of the allocated tickets; and
a data store configured to store an indication as to how event tickets for the first event are to be allocated to the at least two different distribution channels.

15. The computer system as defined in claim 14, further comprising:
a web proxy system, including a load balancer and web proxy processors, wherein the web proxy system is configured to selectively block or route inbound requests from remote terminals to a selected destination;
a queue configured to receive requests from the web proxy system;
a transaction system including a load balancer and transaction processors configured to generate transactional pages, populate data caches, provide logic and/or rules for the transaction flows, transmit queue related messaging; and
a cache cluster system including a load balancer and cluster system processors, wherein the cache cluster system is configured to cache data and states for access by other computer system components.

16. The computer system as defined in claim 14, further comprising a servo system configured to provide a suggestion regarding ticket allocations for the first event based at least in part on how many ticket requests have been received via the first channel.

17. The computer system as defined in claim 14, further comprising a data store that stores a sale rate for sales made via the first channel, wherein the sale rate is used at least in part to determine exchange rates for at least a portion of the allocated tickets

18. The computer system as defined in claim 14, wherein the two different distribution channels include an auction channel and a fixed price channel.

19. The computer system as defined in claim 14, wherein the two different distribution channels include an auction channel and a channel via which a plurality of sellers can sell tickets to the first event.

20. The computer system as defined in claim 14, wherein the two different distribution channels include:
a fixed price channel, wherein once tickets are offered at a specified price, the price will not be increased for those tickets; and
a channel wherein tickets are offered at a specified price, but the seller has the option to increase the price prior to sale.

21. A method of distributing resources, the method comprising:
storing in computer readable memory an allocation indication regarding an allocation of a first subset of resources to a first auction distribution channel using a computer system, wherein resources not included in the first subset of resources are not to be offered to users until offerings via the first auction distribution channel have concluded;
causing, at least in part, information regarding the first auction distribution channel to be transmitted over a data network to user terminals;
storing information related to how many winning bids were received for resources in the first set of resources in computer readable memory;
storing information related to exchange rates associated with the winning bids for resources in the first set of resources in computer readable memory;
based at least in part on the winning bid related information, allocating a second subset of resources to a first fixed exchange rate distribution channel;
based at least in part on information related to exchange rates associated with the winning bids for resources in the first set of resources, setting and storing in computer readable memory one or more fixed exchange rates to be used in association with the first fixed exchange rate distribution channel;
allocating a third subset of resources to a second auction distribution channel;
causing, at least in part, information regarding the second auction distribution channel to be transmitted over the data network to user terminals;
storing in computer readable memory information related to how many winning bids were received for resources in the third set of resources in computer readable memory;
storing in computer information related to exchange rates associated with the winning bids with respect to the third set of resources in computer readable memory; and
based at least in part on the winning bid related information for the third set of resources, allocating a fourth subset of resources to at least one distribution channel;
based at least in part on information related to exchange rates associated with the winning bids for the third set of resources, setting and storing in computer readable memory one or more fixed exchange rates, to be used in association with at least one fixed exchange rate distribution channel.

22. The method as defined in claim 21, wherein the exchange rate for at least one distribution channel is set based at least in part on information accessed from computer readable memory indicating how many remaining resources of a first type are available for allocation.

23. The method as defined in claim 21, wherein timing associated with at least one distribution channel is based at least in part on a minimum pre-specified interval between initiation of different distribution channels for the first event.

24. The method as defined in claim 21, wherein an exchange rate for a first plurality of resources that is to be distributed via at least one of the distribution channels is set based at least in part on information accessed from computer readable memory including:
a specified maximum exchange rate; and
a specified minimum exchange rate, wherein the specified maximum exchange rate and the specified minimum exchange rate are different.

25. The method as defined in claim 21, wherein an exchange rate for a first plurality of resources that is to be distributed via at least one of the distribution channels is set based at least in part on information accessed from computer readable memory including:
a specified maximum permissible exchange rate adjustment increment; and
a specified minimum permissible exchange rate adjustment increment.

26. The method as defined in claim 21, wherein the number of resources allocated to the first auction distribution channel is limited to a pre-specified maximum permissible number of resources that are to be allocated using the first auction distribution channel, wherein the pre-specified maximum is less than all available resources and wherein less than the pre-specified maximum can be allocated to the first auction distribution channel.

27. The method as defined in claim 21, wherein the first subset of resources includes tickets associated with seats, and wherein at least a portion of the seats are in different rows, wherein only a portion of a seats for a first row are associated with tickets in the first subset of resources and where seating not included in the first subset of resources are not sold via the first channel.

28. A method of distributing resources, the method comprising:
using a computer system to measure the progression and/or results of a first dynamically-priced ticket sale of a first set of tickets for an event, the first dynamically-priced ticket sale performed at least in part prior to the offer for sale of a second set of tickets via a fixed price sale;
based at least in part on information related to the progression and/or results of the first dynamically-priced ticket sale of the first set of tickets:
assigning, via the computer system, a number of tickets to be included in the second set of tickets, the second set of tickets including a first subset of tickets at a first fixed ticket price, and a second subset of tickets at a second fixed ticket price;
storing in computer readable memory an indication as to which tickets are in the first subset and the corresponding first fixed ticket price;
storing in computer readable memory an indication as to which tickets are in the second subset and the corresponding second fixed ticket price;
storing in computer readable memory sales information related to the second set of tickets;
using the computer system to measure the progression and/or results of a second dynamically-priced ticket sale of a third set of tickets for the event, the second dynamically-priced ticket sale performed at least in part after the offer for sale of the second set of tickets via a fixed price sale; and
based at least in part on information related to the progression and/or results of the second dynamically-priced ticket sale of the second set of tickets,
assigning a number of tickets for the event to be offered for sale at a third fixed price.

29. The method as defined in claim 28, further comprising using a servo system to provide a suggestion regarding ticket allocations for the event based at least in part on progression and/or results of the first dynamically-priced ticket sale.

30. The method as defined in claim 28, the method further comprising:
selling over a network a first ticket of similar quality to that of a ticket in the first subset at a price different than the first fixed ticket price via a non-auction sales channel,
wherein the non-auction sales channel is configured to sell tickets from multiple sellers at prices correspondingly set at least in part by the multiple sellers.

31. The method as defined in claim 28, wherein the act of assigning the number of tickets to be included in the second set of tickets is based at least in part on the information related to:
the progression of the first dynamically-priced ticket sale; and
on the results of the first dynamically-priced ticket sale.

32. The method as defined in claim 28, wherein the act of assigning the number of tickets to be included in the second set of tickets is based at least in part on the information related to the progression of the first dynamically-priced ticket sale, including the rate of sales for at least a first time period.

33. The method as defined in claim 28, wherein the act of assigning the number of tickets to be included in the second set of tickets is based at least in part on the information related to the progression of the first dynamically-priced ticket sale, including the distribution of sales during the first dynamically-priced ticket sale.

34. The method as defined in claim 28, further comprising assigning the first fixed ticket price based at least in part on bid amounts in the first dynamically-priced ticket sale.

35. The method as defined in claim 28, further comprising assigning the first fixed ticket price based at least in part on information related to how many bids were received in the first dynamically-priced ticket sale.

36. The method as defined in claim 28, further comprising assigning the first fixed ticket price based at least the average or mean of winning bids received in the first dynamically-priced ticket sale.

37. The method as defined in claim 28, the method further comprising defining a first bid group and a second bid group for the second dynamically-priced ticket sale based at least in part on sales information for the second set of tickets, wherein the first bid group is associated with a different minimum bid than the second bid group.

38. The method as defined in claim 37, wherein the quality of seats associated with the first bid group is higher then the quality of seats associated with the second bid group.

39. The method as defined in claim 28, the method further comprising selecting a start time for the second dynamically-priced ticket sale based at least in part on sales information of the second set of tickets.
